(19) United States
(12) Patent Application Publication
(10) Pub. No.: US 2025/0063584 A1
(43) Pub. Date: Feb. 20, 2025

(54) TRANSMISSION RESOURCE SELECTION METHOD, AND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(21) Appl. No.: 18/937,570

(22) Filed: Nov. 5, 2024

Related U.S. Application Data
(63) Continuation of application No. PCT/CN2022/109497, filed on Aug. 1, 2022.

(51) Int. Cl. H04W 72/50

(52) U.S. Cl. CPC H04W 72/535

(57) ABSTRACT

A transmission resource selection method, which includes: determining, by a first terminal, a first transmission resource based on values of first parameters respectively corresponding to one or more resource pools on each of N carriers; where a first parameter is used for indicating a resource usage state; the first transmission resource is used for data transmission; and N is an integer greater than 1.

### CROSS-REFERENCE TO RELATED APPLICATION

This application is a Continuation Application of International Application No. PCT/CN2022/109497 filed on Aug. 1, 2022, which is incorporated herein by reference in its entirety.

### TECHNICAL FIELD

The present disclosure relates to the field of communications, and more particularly, to a transmission resource selection method, a device, a computer-readable storage medium, a computer program product and a computer program.

### BACKGROUND

Device to Device (D2D) communication belongs to a sidelink (SL) transmission technology. Different from a manner of receiving or transmitting communication data through a base station in a traditional cellular system, a communication system of device to device adopts a manner of terminal-to-terminal direct communication. However, how to select transmission resources more accurately has become a problem that needs to be solved.

### SUMMARY

Embodiments of the present disclosure provide a transmission resource selection method, a device, a computer-readable storage medium, a computer program product and a computer program.

The embodiments of the present disclosure provide a transmission resource selection method, and the method includes:
determining, by a first terminal, a first transmission resource based on values of first parameters respectively corresponding to one or more resource pools on each of N carriers; where a first parameter is used for indicating a resource usage state; the first transmission resource is used for data transmission; and N is an integer greater than 1.

The embodiments of the present disclosure provide provides a first terminal, and the first terminal includes:
a processing unit, configured to determine a first transmission resource based on values of first parameters respectively corresponding to one or more resource pools on each of N carriers; where a first parameter is used for indicating a resource usage state; the first transmission resource is used for data transmission; and N is an integer greater than 1.

The embodiments of the present disclosure provide a first device, which includes a processor and a memory. The memory is configured to store a computer program, and the processer is configured to call and run the computer program stored in the memory, to cause the first device to perform the above method.

The embodiments of the present disclosure provide a chip to implement the above method.

Exemplarily, the chip includes a processor, and the processer is configured to call and run a computer program from a memory, to cause a device equipped with the chip to perform the above method.

The embodiments of the present disclosure provide a computer-readable storage medium, which is configured to store a computer program, and the computer program, when being executed by a device, causes the device to perform the above method.

The embodiments of the present disclosure provide a computer program product, which includes computer program instructions. The computer program instructions cause a computer to perform the above method.

The embodiments of the present disclosure provide a computer program, where the computer program, when being executed on a computer, causes the computer to perform the above method.

### BRIEF DESCRIPTION OF THE DRAWINGS

FIG. 1 is a schematic diagram of an application scenario according to embodiments of the present disclosure.

FIG. 2A and FIG. 2B are schematic diagrams of D2D scenarios according to the present disclosure.

FIG. 3 is a schematic flow diagram of a transmission resource selection method according to an embodiment of the present disclosure.

FIG. 4 is a schematic flowchart of a transmission resource selection method according to an embodiment of the present disclosure.

FIG. 5 is another schematic flowchart of a transmission resource selection method according to an embodiment of the present disclosure.

FIG. 6 is a schematic block diagram of a first terminal according to an embodiment of the present disclosure.

FIG. 7 is a schematic block diagram of a communication device according to embodiments of the present disclosure.

FIG. 8 is a schematic block diagram of a chip according to embodiments of the present disclosure.

FIG. 9 is a schematic block diagram of a communication system according to embodiments of the present disclosure.

### DETAILED DESCRIPTION

Technical solutions of the embodiments of the present disclosure will be described below in conjunction with the accompanying drawings in the embodiments of the present disclosure.

The technical solutions of the embodiments of the present disclosure may be applied to various communication systems, such as, a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (Non-Terrestrial Networks, NTN) system, a universal mobile telecommunication system (UMTS), wireless local area networks (WLAN), wireless fidelity (WiFi), a fifth-generation communication (5th-Generation, 5G) system, or other communication systems.

Generally speaking, traditional communication systems support a limited number of connections which are easy to be implemented. However, with development of the communication technology, mobile communication systems will support not only the traditional communication, but also, for example, device to device (D2D) communication, machine to machine (M2M) communication, machine type communication (MTC), vehicle to vehicle (V2V) communication, or vehicle to everything (V2X) communication. The embodiments of the present disclosure may also be applied to these communication systems.

In a possible implementation, a communication system in the embodiments of the present disclosure may be applied to a carrier aggregation (CA) scenario, may also be applied to a dual connectivity (DC) scenario, and may also be applied to a standalone (SA) network deployment scenario.

In a possible implementation, the communication system in the embodiments of the present disclosure may be applied to an unlicensed spectrum, where the unlicensed spectrum may also be considered as a shared spectrum; or the communication system in the embodiments of the present disclosure may also be applied to a licensed spectrum, where the licensed spectrum may also be considered as an unshared spectrum.

In the embodiments of the present disclosure, each embodiment will be described in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (STATION, STA) in the WLAN, which may be a cellular phone, a cordless phone, a session initiation protocol (SIP) phone, a wireless local loop (WLL) station, or a personal digital assistant (PDA) device, a handheld device with wireless communication functions, a computing device or other processing devices connected to a wireless modem, an in-vehicle device, a wearable device, a terminal device in a next generation communication system (e.g., an NR network), a terminal device in a future evolved public land mobile network (PLMN) network, or the like.

In the embodiments of the present disclosure, the terminal device may be deployed on land, which includes indoor or outdoor, handheld, wearable, or in-vehicle; the terminal device may also be deployed on water (e.g., on a steamship); and the terminal device may also be deployed in air (e.g., on an airplane, on a balloon, or on a satellite).

In the embodiments of the present disclosure, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, or the like.

As an example but not a limitation, in the embodiments of the present disclosure, the terminal device may also be a wearable device. The wearable device may also be referred to as a wearable smart device, which is a generic term for a wearable device by using wearable technology and intelligent design for everyday wear, such as glasses, gloves, a watch, clothing, or shoes. The wearable device is a portable device that is worn directly on a body, or integrated into a user's clothing or accessories. The wearable device is not only a hardware device, but also achieves powerful functions through software supporting as well as data interaction or cloud interaction. Generalized wearable smart devices includes full-featured, large-sized devices that may implement full or partial functionality without relying on smart phones, such as a smart watch or smart glasses, and devices that focus on a certain type of application functionality only and need to be used in conjunction with other devices (such as smart phones), such as various smart bracelets or smart jewelries for monitoring physical signs.

In the embodiments of the present disclosure, the network device may be a device used for communicating with a mobile device. The network device may be an access point (AP) in the WLAN, a base station (Base Transceiver Station, BTS) in the GSM or CDMA, may also be a base station (NodeB, NB) in the WCDMA, or may also be an evolutional base station (Evolutional Node B, eNB or eNodeB) in the LTE, a relay station or an access point, a network device (gNB) in an in-vehicle device, a wearable device and an NR network, a network device in the future evolved PLMN network, a network device in the NTN network, or the like.

As an example but not a limitation, in the embodiments of the present disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite. Optionally, the network device may also be a base station deployed on land, water, and other places.

In the embodiments of the present disclosure, the network device may provide services for a cell, and the terminal device communicates with the network device through transmission resources (such as frequency domain resources, or frequency spectrum resources) used by the cell. The cell may be a cell corresponding to the network device (such as the base station). The cell may belong to a macro base station or a base station corresponding to a small cell. The small cell here may include a metro cell, a micro cell, a pico cell, a femto cell, or the like. These small cells have characteristics of small coverage range and low transmission power, which are applicable for providing a data transmission service with high speed.

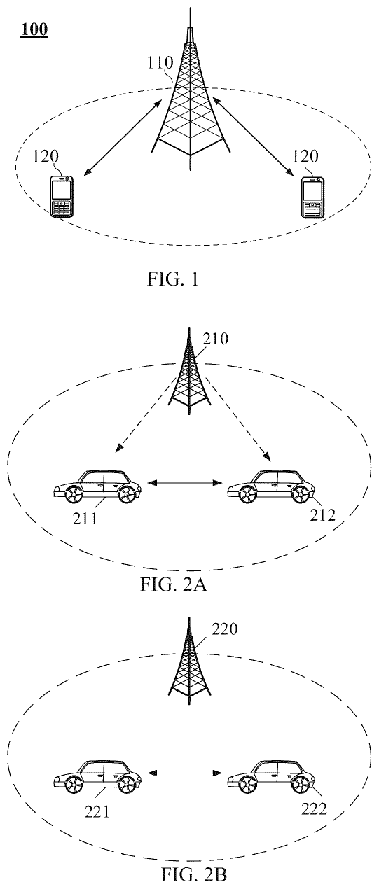

FIG. 1 exemplarily illustrates a communication system 100. The communication system includes one network device 110 and two terminal devices 120. In a possible implementation, the communication system 100 may include multiple network devices 110, and may include other numbers of terminal devices 120 within a coverage range of each network device 110, which is not limited in the embodiments of the present disclosure.

In a possible implementation, the communication system 100 may also include other network entities such as a mobility management entity (MME), an access and mobility management function (AMF), which are not limited in the embodiments of the present disclosure.

The network device may also include an access network device and a core network device. That is, the wireless communication system also includes multiple core networks for communicating with the access network device. The access network device may be a evolutional base station (evolutional node B, abbreviated as eNB or e-NodeB), a macro base station, a micro base station (also referred to as a “small base station”), a pico base station, an access point (AP), a transmission point (TP), a new generation base station (new generation Node B, gNodeB) or the like, in a long-term evolution (LTE) system, a next generation (mobile communication system) (e.g., next radio, NR) system or an authorized auxiliary access long-term evolution (LAA-LTE) system.

It should be understood that a device having a communication function in the network or system in the embodiments of the present disclosure may be referred to as a communication device. Taking the communication system shown in FIG. 1 as an example, the communication device may include the network device and the terminal device with the communication function, and the network device and the terminal device may be specific devices in the embodiments of the present disclosure, which will not be repeated here. The communication device may further include other devices in the communication system, such as a network controller, a mobility management entity, and other network entities, which are not limited in the embodiments of the present disclosure.

In order to facilitate understanding of the embodiments of the present disclosure, basic procedures and basic concepts involved in the embodiments of the present disclosure are briefly described below. It should be understood that the basic procedures and basic concepts described below do not limit the embodiments of the present disclosure.

Device to device communication belongs to a sidelink (SL) transmission technology based on D2D. Different from a manner of receiving or transmitting communication data through a base station in a traditional cellular system, a vehicle to everything system adopts a manner of terminal-to-terminal direct communication, so it has higher spectral efficiency and lower transmission delay. Two transmission modes are defined in 3GPP: mode A and mode B. Regarding to the mode A, as shown in FIG. 2A, transmission resources of terminal devices are allocated by a network device 210, and the terminal devices (a terminal device 211 and terminal device 212 in FIG. 2A) perform data transmission on a sidelink according to the resources allocated by the network device 210. The network device may allocate resources for single transmission to terminals, or may allocate resources for semi-static transmission to the terminal devices. A bidirectional solid arrow in FIG. 2A is used to represent a sidelink between the terminal device 211 and the terminal device 212; and dashed arrows in FIG. 2A are used to represent downlinks used by the network device 210 to allocate the resources for transmission to the terminal device 211 (or the terminal device 212). Regarding to the mode B, as shown in FIG. 2b, terminal devices, specifically in-vehicle terminals, select one resource in a resource pool for data transmission. A bidirectional solid arrow in FIG. 2b is used to represent a sidelink between a terminal device 221 and a terminal device 222, and it can be seen in FIG. 2b that a network device 220 does not allocate resources for transmission to the terminal device 221 or the terminal device 222.

In the 3rd Generation Partnership Project (3GPP), D2D is divided into different stages for research. Proximity based Service (ProSe): which is mainly for services of public safety category; and in the ProSe, by configuring positions of a resource pool on a time domain, for example, the resource pool is discontinuous on the time domain, the terminal device transmits/receives data discontinuously on a sidelink, thereby achieving an effect of power saving. Vehicle to everything (V2X): which is mainly oriented to services of vehicle-to-vehicle communication and vehicle-to-person communication with relatively high-speed mobility; and in the V2X, since a vehicle system has continuous power supply, delay of data transmission is a main problem, and the terminal device is required to transmit and receive continuously by a system design. Wearable devices (Further Enhancements to LTE Device to Device, FeD2D): which is mainly oriented to scenarios with low moving speed and low power access; and in the FeD2D, in a pre-research stage, 3GPP concluded that a network device may configure Discontinuous Reception (DRX) parameters of a remote terminal through a relay terminal, however, since this issue has not further entered a standardization stage, there is no conclusion on specific details of how to configure DRX.

On the basis of LTE V2X, NR V2X is not limited to broadcast scenarios, but further expands to unicast and multicast scenarios, and studies V2X applications in these scenarios. Similar to the LTE V2X, the NR V2X will also define the above two resource authorization modes, i.e., mode-1/2. Further, the terminal device may be in a hybrid mode, that is, the terminal device may use the mode-1 and mode-2 for resource acquisition at the same time. The resource acquisition is indicated by means of a sidelink authorization, that is, the sidelink authorization indicates time-frequency positions of corresponding PSCCH and PSSCH resources. Different from the LTE V2X, in addition to HARQ retransmission of feedback-free and independently initiated by the terminal device, feedback-based HARQ retransmission is introduced in the NR V2X, which is not limited to unicast communication but also includes multicast communication.

Carrier selection in LTE-V2X carrier aggregation is completed by the following mechanism: an upper layer configures a mapping relationship between service types and carriers, that is, for a certain service, the upper layer indicates available carriers (sets) to an AS layer. Further, the AS layer configures available carrier sets for each logical channel and a CBR measurement threshold value configured for data priority in each resource pool. A UE measures a CBR value in the resource pool and compares a measured value with a CBR threshold value corresponding to a priority of transmitted data, and if the measured value is lower than the CBR threshold value, corresponding carrier is considered to be available.

Both the LTE V2X and NR V2X support CBR/channel occupancy ratio (CR) measurement, which is mainly used for congestion control in a terminal-based autonomous resource selection mode. Definitions of CBR/CR in the LTE V2X and NR V2X are basically the same, except that the NR V2X has some differences in parameter values due to supporting multi-subcarrier spacing. The definition of CBR is that, in a CBR measurement window, a ratio of a number of sub-channels whose SL RSSIs are higher than a configuration threshold to a total number of sub-channels in a resource pool, where the CBR measurement window is equal to 100 side-subframes in the LTE V2X, and the CBR measurement window is equal to 100 ms or 100.2″ side-slots according to parameters configured a higher layer in the NR V2X. It should be noted that, in the LTE V2X, since a PSSCH and a PSCCH may not be adjacent to each other and corresponding resource pools are configured separately, the CBR measurement may be performed for the resource pool in which the PSSCH is located and the resource pool in which the PSCCH is located. A PSCCH in the NR V2X occupies a same resource pool as an indicated PSSCH, thus, the CBR measurement is not distinguished based on the PSSCH and PSCCH.

Carrier aggregation (CA) means that multiple component carriers (CCs) can be aggregated together, and received or transmitted by one terminal device simultaneously. According to a range of aggregated carriers, CA may be divided into intra-band CA and inter-band CA. One of main usages of the intra-band CA is for scenarios where a cell carrier bandwidth is greater than a carrier bandwidth corresponding to single carrier bandwidth capability of the terminal device. In such case, the terminal device may implement operations in a “wide carrier” by means of CA. For example, the network device supports a carrier with 300 MHz, while the terminal device only supports a carrier with a maximum of 100 MHz, at this time, the terminal device may implement wide band operations greater than 100 MHz by means of CA, and aggregated carriers may be adjacent carriers or non-adjacent carriers.

When the terminal device and the network device communicate through carrier aggregation (CA), a primary cell and a secondary cell (SCell) may be configured simultaneously. A beam failure recovery mechanism is designed for the primary cell (PCell) and the primary secondary cell (PSCell), and main functional modules (or referred to as main steps) of the beam failure recovery mechanism are divided into the four: Beam Failure Detection (BFD); New Beam Identification (NBI); Beam Failure Recovery Request (Beam Failure Recovery ReQest, BFRQ); and network side response. Exemplarily, the terminal device performs measurement on a Physical Downlink Control Channel (PDCCH) to determine link quality corresponding to a downlink transmission beam. If the corresponding link quality is very poor, beam failure occurs on the downlink beam; the terminal device performs measurements on a set of candidate beams, and selects a beam that meets the threshold as a new beam; and the terminal device reports the network that the beam failure has occurred and reports the new beam through BFRQ information. After receiving the BFRQ information transmitted by one terminal device, the network device determines that the beam failure has occurred on the terminal device, and selects to transmit a PDCCH on the new beam. When the terminal device receives the PDCCH transmitted by the network device on the new beam, it is determined that response information from the network side has been correctly received, and at this point, a beam failure recovery procedure is successfully completed.

It should be understood that, the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that, “indication” mentioned in the embodiments of the present disclosure may be direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated, a relationship of configuring and being configured, or the like.

In order to facilitate understanding of the technical solutions of the embodiments of the present disclosure, related technologies of the embodiments of the present disclosure are described below, and the following related technologies may be, as optional solutions, arbitrarily combined with the technical solutions of the embodiments of the present disclosure, all of which belong to the protection scope of the embodiments of the present disclosure.

The embodiments of the present disclosure provide a transmission resource selection method, and the method includes:
determining, by a first terminal, a first transmission resource based on values of first parameters respectively corresponding to one or more resource pools on each of N carriers; where a first parameter is used for indicating a resource usage state; the first transmission resource is used for data transmission; and N is an integer greater than 1.

In some embodiments, where determining, by the first terminal, the first transmission resource based on the values of the first parameters respectively corresponding to the one or more resource pools on each of the N carriers includes:
determining, by the first terminal, a first reference value of each of the N carriers based on the values of the first parameters respectively corresponding to the one or more resource pools on each of the N carriers, where the first reference value is used to indicate a resource usage state of a carrier; and
determining the first transmission resource based on the first reference value of each of the N carriers.

In some embodiments, where determining, by the first terminal, the first reference value of each of the N carriers based on the values of the first parameters respectively corresponding to the one or more resource pools on each of the N carriers includes:
determining, by the first terminal, a first reference value of an i-th carrier based on values of first parameters respectively corresponding to at least part of one or more resource pools on the i-th carrier;
where the i-th carrier is one of the N carriers; i is a positive integer less than or equal to N, or i is an integer less than N and greater than or equal to 0.

In some embodiments, where the at least part of one or more resource pools on the i-th carrier includes one of:
all resource pools of the one or more resource pools on the i-th carrier; and
one or more specified resource pools of the one or more resource pools on the i-th carrier.

In some embodiments, where determining, by the first terminal, the first reference value of the i-th carrier based on the values of the first parameters respectively corresponding to the at least part of one or more resource pools on the i-th carrier includes:
in a case where a number of the at least part of one or more resource pools on the i-th carrier is 1, taking a value of a first parameter corresponding to the at least part of one or more resource pools on the i-th carrier as the first reference value of the i-th carrier.

In some embodiments, where determining, by the first terminal, the first reference value of the i-th carrier based on the values of the first parameters respectively corresponding to the at least part of one or more resource pools on the i-th carrier includes:
in a case where a number of the at least part of one or more resource pools on the i-th carrier is greater than 1, performing, by the first terminal based on a target mode, processing on the values of the first parameters respectively corresponding to the at least part of one or more resource pools on the i-th carrier, to obtain the first reference value of the i-th carrier; where the target mode is configured by a network device, or determined by the first terminal, or configured by a second terminal, or specified by a protocol.

In some embodiments, where there is a first mapping relationship between the target mode and a second parameter, and the second parameter is a service-related parameter.

In some embodiments, where the target mode includes one of:
taking one of the values of the first parameters respectively corresponding to the at least part of one or more resource pools on the i-th carrier as the first reference value of the i-th carrier; and
performing calculation on the values of the first parameters respectively corresponding to the at least part of one or more resource pools on the i-th carrier, to obtain the first reference value of the i-th carrier.

In some embodiments, where the one of the values of the first parameters respectively corresponding to the at least part of one or more resource pools on the i-th carrier includes one of:
a maximum value in the values of the first parameters respectively corresponding to the at least part of one or more resource pools on the i-th carrier;
a minimum value in the values of the first parameters respectively corresponding to the at least part of one or more resource pools on the i-th carrier; and
an arbitrary value in the values of the first parameters respectively corresponding to the at least part of one or more resource pools on the i-th carrier.

In some embodiments, where performing calculation on the values of the first parameters respectively corresponding to the at least part of one or more resource pools on the i-th carrier, to obtain the first reference value of the i-th carrier includes:
performing average calculation on the values of the first parameters respectively corresponding to the at least part of one or more resource pools on the i-th carrier, to obtain the first reference value of the i-th carrier.

In some embodiments, where a value of a first parameter corresponding to each of the one or more resource pools on the i-th carrier is measured by the first terminal or a default value.

In some embodiments, where the all resource pools of the one or more resource pools on the i-th carrier are configured by a network device, or determined by the first terminal, or configured by a second terminal.

In some embodiments, where the one or more specified resource pools of the one or more resource pools on the i-th carrier are configured by a network device, or determined by the first terminal, or configured by a second terminal, or specified by a protocol, or default.

In some embodiments, where there is a second mapping relationship between the one or more specified resource pools of the one or more resource pools on the i-th carrier and a second parameter; and the second parameter is a service-related parameter.

In some embodiments, the method further includes:
receiving, by the first terminal, first configuration information transmitted by the second terminal; where the first configuration information includes related information of the one or more specified resource pools of the one or more resource pools on the i-th carrier.

In some embodiments, where the one or more specified resource pools of the one or more resource pools on the i-th carrier comprise at least one of: a resource pool in which a resource monitored by the second terminal on the i-th carrier is located; or a resource pool in which a resource whose interference value less than a preset interference threshold value of one or more resources monitored by the second terminal on the i-th carrier is located.

In some embodiments, where determining the first transmission resource based on the first reference value of each of the N carriers includes:
selecting, by the first terminal based on the first reference value of each of the N carriers, K first available carriers whose first reference values are less than a first preset threshold, where K is a positive integer less than or equal to N; and
determining, by the first terminal from the K first available carriers, a first carrier as the first transmission resource.

In some embodiments, where determining, by the first terminal from the K first available carriers, the first carrier as the first transmission resource includes:
selecting, by the first terminal from the K first available carriers, a first available carrier with a minimum first reference value as the first carrier, and taking the first carrier as the first transmission resource.

In some embodiments, where determining, by the first terminal from the K first available carriers, the first carrier as the first transmission resource includes:
transmitting, by the first terminal, first information to a second terminal, where the first information is used to indicate that the second terminal transmits a suggested carrier;
receiving, by the first terminal, second information transmitted by the second terminal, where the second information includes a carrier suggested by the second terminal; and
determining, by the first terminal, the first carrier according to related information of the K first available carriers and/or the second information, and taking the first carrier as the first transmission resource.

In some embodiments, where the first information includes the related information of the K first available carriers.

In some embodiments, where the carrier suggested by the second terminal is a carrier used by the second terminal.

In some embodiments, where the carrier used by the second terminal includes at least one of: a carrier used by the second terminal on a sidelink with a third device; or a carrier used by the second terminal on a link with a network device.

In some embodiments, the method further includes:
determining, by the first terminal, a reselected first transmission resource based on a first reference value of a second carrier and/or values of first parameters respectively corresponding to one or more resource pools on the second carrier; where the second carrier is a carrier currently used by the first terminal for data transmission, and the second carrier is one of the N carriers.

In some embodiments, where the first reference value of the second carrier is determined based on values of first parameters respectively corresponding to the at least part of one or more resource pools on the second carrier.

In some embodiments, where the at least part of one or more resource pools on the second carrier further includes: a first resource pool on the second carrier; where the first resource pool is a resource pool in which a resource currently used by the first terminal for data transmission is located.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is less than a second preset threshold value and/or a value of a first parameter of a first resource pool on the second carrier is less than a third preset threshold value, taking, by the first terminal, the second carrier as the reselected first transmission resource.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is not less than a second preset threshold value, selecting, by the first terminal, a third carrier, and taking the third carrier as the reselected first transmission resource; where the third carrier is different from the second carrier.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is less than a second preset threshold value and a value of a first parameter of a first resource pool on the second carrier is not less than a third preset threshold value, selecting, by the first terminal, a third carrier, and taking the third carrier as the reselected first transmission resource; where the third carrier is different from the second carrier.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is less than a second preset threshold value and/or a value of a first parameter of a first resource pool on the second carrier is less than a third preset threshold value, taking, by the first terminal, the first resource pool on the second carrier as the reselected first transmission resource; where the first resource pool is a resource pool in which a resource currently used by the first terminal for data transmission is located.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is less than a second preset threshold value and a value of a first parameter of a first resource pool is not less than a third preset threshold value, selecting, by the first terminal, a second resource pool on the second carrier; where the second resource pool is one of one or more third resource pools on the second carrier other than the first resource pool; and
determining, by the first terminal, that the second resource pool on the second carrier is the reselected first transmission resource.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is not less than a second preset threshold value and/or a value of a first parameter of a first resource pool is less than a third preset threshold value, selecting, by the first terminal, a second resource pool on the second carrier; where the first resource pool is a resource pool in which a resource currently used by the first terminal for data transmission is located, and the second resource pool is one of one or more third resource pools on the second carrier other than the first resource pool; and
determining, by the first terminal, that the second resource pool on the second carrier is the reselected first transmission resource.

In some embodiments, where a value of a first parameter of each of the one or more third resource pools is less than the third preset threshold value.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is not less than a second preset threshold value and/or a value of a first parameter of a first resource pool is less than a third preset threshold value, taking, by the first terminal, the first resource pool on the second carrier as the reselected first transmission resource; where the first resource pool is a resource pool in which a resource currently used by the first terminal for data transmission is located.

In some embodiments, where determining, by the first terminal, the reselected first transmission resource based on the first reference value of the second carrier and/or the values of the first parameters respectively corresponding to the one or more resource pools on the second carrier includes:
in a case where the first reference value of the second carrier is not less than a second preset threshold value and/or a value of a first parameter of a first resource pool is not less than a third preset threshold value, selecting, by the first terminal, a third carrier; where the third carrier is different from the second carrier, and the first resource pool is a resource pool in which a resource currently used by the first terminal for data transmission is located; and
determining, by the first terminal, a fourth resource pool on the third carrier, and taking the fourth resource pool on the third carrier as the first transmission resource.

In some embodiments, where selecting, by the first terminal, the third carrier includes:
selecting, by the first terminal based on first reference values respectively corresponding to multiple carriers, one or more second available carriers whose first reference values are less than a first preset threshold value, where the multiple carriers do not comprise the second carrier; and
determining, by the first terminal, the third carrier from the one or more second available carriers.

In some embodiments, where determining, by the first terminal, the third carrier from the one or more second available carriers includes:
selecting, by the first terminal, a third carrier with a minimum first reference value from the one or more second available carriers.

In some embodiments, wherein determining, by the first terminal, the third carrier from the one or more second available carriers includes:
transmitting, by the first terminal, third information to a second terminal, where the third information is used to indicate that the second terminal transmits a suggested carrier;
receiving, by the first terminal, fourth information transmitted by the second terminal, where the fourth information includes a carrier suggested by the second terminal; and
determining, by the first terminal, the third carrier based on related information of the one or more second available carriers and/or the fourth information.

In some embodiments, where the third information includes the related information of the one or more second available carriers.

In some embodiments, where the N carriers are N third available carriers; and
determining, by the first terminal, the first transmission resource based on the values of the first parameters respectively corresponding to the one or more resource pools on each of the N carriers includes:
selecting, by the first terminal from one or more resource pools on each of the N third available carriers, a fourth resource pool whose value of a first parameter is less than a fourth preset threshold value; and taking the fourth resource pool as the first transmission resource.

In some embodiments, where the N third available carriers are configured by a network device, or determined by the first terminal, or configured by a second terminal.

In some embodiments, where there is a third mapping relationship between the N third available carriers and a second parameter, and the second parameter is a service-related parameter.

In some embodiments, where selecting, by the first terminal, the fourth resource pool whose value of the first parameter is less than the fourth preset threshold value from the one or more resource pools on each of the N third available carriers; and taking the fourth resource pool as the first transmission resource includes:
selecting, by the first terminal from the one or more resource pools on each of the N third available carriers, one or more candidate resource pools whose values of first parameters are less than the fourth preset threshold value; and
selecting, by the first terminal, the fourth resource pool from the one or more candidate resource pools.

In some embodiments, where selecting, by the first terminal, the fourth resource pool from the one or more candidate resource pools includes at least one of:
selecting, by the first terminal from the one or more candidate resource pools, a candidate resource pool with a minimum value of a first parameter as the fourth resource pool; or
selecting, by the first terminal from the one or more candidate resource pools, a candidate resource pool with a highest priority as the fourth resource pool.

In some embodiments, the method further includes:
in a case where a value of a first parameter of a fifth resource pool is less than a fifth preset threshold value, taking, by the first terminal, the fifth resource pool as a reselected first transmission resource; where the fifth resource pool is a resource pool in which a resource currently used by the first terminal for data transmission is located.

In some embodiments, the method further includes:
in a case where a value of a first parameter of a fifth resource pool is not less than a fifth preset threshold value, selecting, by the first terminal, a sixth resource pool from one or more resource pools on a carrier in which the fifth resource pool is located; where the fifth resource pool is a resource pool in which a resource currently used by the first terminal for data transmission is located; and
taking, by the first terminal, the sixth resource pool as a reselected first transmission resource.

In some embodiments, where selecting, by the first terminal, the sixth resource pool from the one or more resource pools on the carrier in which the fifth resource pool is located includes at least one of:
selecting, from the one or more resource pools on the carrier in which the fifth resource pool is located, a sixth resource pool whose value of a first parameter is less than the fifth preset threshold value; or
selecting, from the one or more resource pools on the carrier in which the fifth resource pool is located, a sixth resource pool with a minimum value of a first parameter.

In some embodiments, the method further includes:
in a case where a value of a first parameter of a fifth resource pool is not less than a fifth preset threshold value, selecting, by the first terminal, a seventh resource pool based on values of first parameters respectively corresponding to the one or more resource pools on each of the N third available carriers; where the fifth resource pool is a resource pool in which a resource currently used by the first terminal for data transmission is located; and
taking, by the first terminal, the seventh resource pool as a reselected first transmission resource.

In some embodiments, where selecting, by the first terminal, the seventh resource pool based on the values of the first parameters respectively corresponding to the one or more resource pools on each of the N third available carriers includes at least one of:
selecting, from the one or more resource pools on each of the N third available carriers, a seventh resource pool whose value of a first parameter is less than the fifth preset threshold value; or
selecting, from the one or more resource pools on each of the N third available carriers, a seventh resource pool with a minimum value of a first parameter.

In some embodiments, where the second parameter includes at least one of: related information of a service, quality of service (QOS), a layer 2 (L2) identifier, a transmission profile, a priority, a logical channel identifier, or a logical channel.

In some embodiments, where the related information of the service includes at least one of: a name of the service or an identifier of the service.

In some embodiments, where the first parameter is a channel busy rate (CBR).

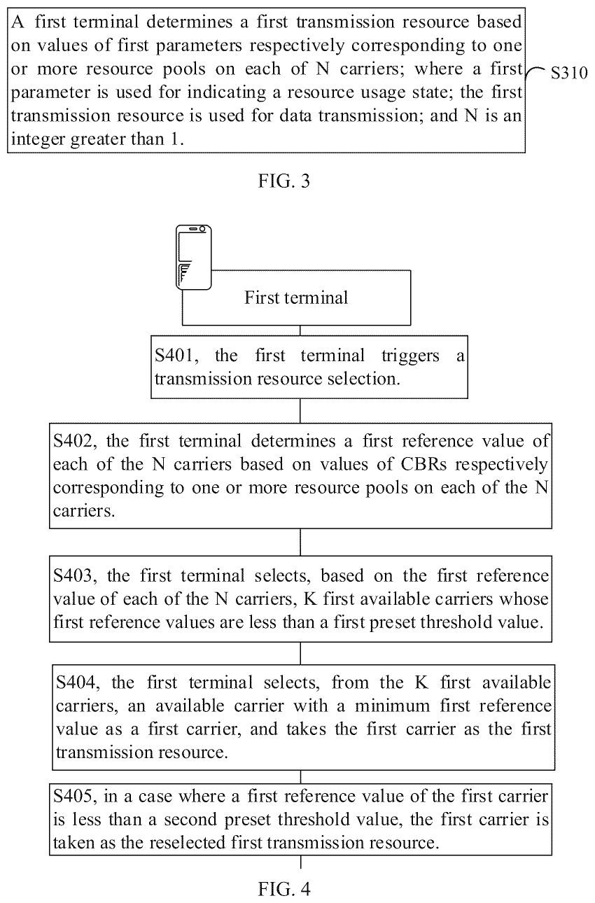

FIG. 3 is a schematic flowchart of a transmission resource selection method according to an embodiment of the present disclosure. The method includes at least part of the following content.

S310, a first terminal determines a first transmission resource based on values of first parameters respectively corresponding to one or more resource pools on each of N carriers; where a first parameter is used for indicating a resource usage state; the first transmission resource is used for data transmission; and N is an integer greater than 1.

The first transmission resource being used for data transmission exemplarily refers to that the first transmission resource is used for sidelink data transmission, that is, the first transmission resource may exemplarily refer to a transmission resource for sidelink data transmission between the first terminal and a second terminal. Where the second terminal and the first terminal are two terminal devices for data transmission and reception on the sidelink, and the second terminal is different from the first terminal, in which the first terminal may be a terminal device at a transmitting end and the second terminal may be a terminal device at a receiving end; alternatively, the first terminal may be a terminal device at a receiving end and the second terminal may be a terminal device at a transmitting end.

A type of the transmission resource may be one of the following: a carrier, a resource pool, a time-frequency resource, or the like.

The first parameters may be a channel busy ratio (CBR). The definition of the CBR is that, in a CBR measurement window, a ratio of a number of sub-channels whose sidelink (SL) received signal strength indicators (RSSIs) are higher than a configuration threshold to a total number of sub-channels in a resource pool. That is, the CBR is intended to indicate a load level, i.e., to evaluate a portion of the resource pool (how many sub-channels) whose RSSI is higher than a certain threshold within a given time, and thus, the CBR provides an indication of a number of channels collectively used by users in the system.

In a possible implementation, there is no available resource on any one of the N carriers, that is, no transmission resource has been selected for data transmission from any one of the N carriers, and thus, the first terminal performs the above S310, namely, performs a primary selection for the transmission resource. In this case, in a preferred example, N is an integer greater than 1.

In the present implementation, the N carriers may be all carriers configured for the first terminal. Any one of the N carriers is referred to as an i-th carrier, where i is a positive integer less than or equal to N, or i is an integer less than N and greater than or equal to 0. Here, i may be an index number of any one of the carriers. In one case, index numbers of the N carriers may be ordered from 1 up to N, where i is a positive integer less than or equal to N. In another case, the index numbers of the N carriers may be ordered from 0 up to N−1, where i is an integer less than N and less than or equal to 0.

Before performing the S310, the first terminal may obtain the values of the first parameters respectively corresponding to the one or more resource pools on each of the N carriers firstly. Any one of the N carriers is referred to as the i-th carrier, where i is a positive integer less than or equal to N, and a value of a first parameter corresponding to each resource pool in one or more resource pools on the i-th carrier is measured by the first terminal or a default value.

The one or more resource pools on the i-th carrier may refer to all resource pools on the i-th carrier.

Exemplarily, a manner of the first terminal obtaining the values of first parameters respectively corresponding to the one or more resource pools on the i-th carrier may include: measuring a j-th resource pool on the i-th carrier to obtain a measured value of a first parameter of the j-th resource pool; and determining a value of the first parameter corresponding to the j-th resource pool based on the measured value of the first parameter corresponding to the j-th resource pool; where j is a positive integer.

The operation of determining the value of the first parameter corresponding to the j-th resource pool based on the measured value of the first parameter corresponding to the j-th resource pool may include: determining the value of the first parameter of the j-th resource pool as the measured value in a case where a measurement result of the first parameter of the j-th resource pool is available; or, configuring the value of the first parameter of the j-th resource pool as a default value in a case where the measurement result of the first parameter of the j-th resource pool is not available. Where the measurement result of the first parameter of the j-th resource pool being not available may mean that: the measurement result of the first parameter of the j-th resource pool is incorrect, or the measurement result of the first parameter of the j-th resource pool is insufficient, and so on, all of which are within the protection scope of the present embodiment, but without exhaustive enumeration.

Here, the j-th resource pool is any one of the one or more resource pools on the i-th carrier, and a manner of determining the value of the first parameter of each of the one or more resource pools on the i-th carrier is the same as the above manner of determining the value of the first parameter of the j-th resource pool on the i-th carrier, and details will not be repeatedly described. Similarly, the i-th carrier is any one of the N carriers, since the manner for acquiring the measured value of a first parameter of each resource pool on each of the N carriers is the same as that of processing the i-th carrier, details will not be repeatedly described.

The above S310 may exemplarily be: determining, by the first terminal, a first reference value of each of the N carriers based on the values of the first parameters respectively corresponding to the one or more resource pools on each of the N carriers, where the first reference value is used to indicate a resource usage state of a carrier; and determining the first transmission resource based on the first reference value of each of the N carriers.

The operation of the first terminal determining the first reference value of each of the N carriers based on the values of the first parameters respectively corresponding to the one or more resource pools on each of the N carriers may include: determining, by the first terminal, a first reference value of an i-th carrier based on values of first parameters respectively corresponding to at least part of one or more resource pools on the i-th carrier; where the i-th carrier is one of the N carriers; i is a positive integer less than or equal to N, or i is an integer less than N and greater than or equal to 0.

The at least part of one or more resource pools on the i-th carrier includes one of: all resource pools of the one or more resource pools on the i-th carrier; and one or more specified resource pools of the one or more resource pools on the i-th carrier.

That is, the one or more resource pools on each of the N carriers may include all resource pools on each of the N carriers, or one or more specified resource pools on each of the N carriers.

Here, a number of the all resource pools of the one or more resource pools on the i-th carrier may be one or multiple, and the number of which is not limited in the embodiments. The all resource pools of the one or more resource pools on the i-th carrier may be configured by a network device, determined by the first terminal, or configured by a second terminal.

The network device may exemplarily refer to a first network device, and the first network device may be an access network device of a cell in which the first terminal is located, for example, may be any one of a base station, a gNB, an eNB, or the like of the cell in which the first terminal is located.

Optionally, the all resource pools of the one or more resource pools on the i-th carrier may be configured by the first network device through third configuration information. The third configuration information may include an identifier of each carrier of the N carriers and related information of the one or more resource pools on each carrier; where the i-th carrier is any one of the N carriers. Related information of any resource pool may be an index number, a serial number or an identifier of the resource pool. The third configuration information may be carried by one of: a radio resource control (RRC) signaling, downlink control information (DCI), a medium access control (MAC) control element (CE), or the like.

Optionally, the all resource pools of the one or more resource pools on the i-th carrier may be determined by the first terminal, which may mean that the first terminal takes one or more resource pools on a preset i-th carrier as the all resource pools on the i-th carrier. Since the i-th carrier is any one of N carriers, the first terminal takes one or more resource pools on each of preset N carriers as all resource pools on the carrier. It should be understood that if the all resource pools on each carrier of the N carriers are determined by the first terminal, the first terminal may further transmit related information of the all resource pools on each of the N carriers (such as, an identifier, or a serial number, or an index number of each resource pool) to the first network device.

Optionally, the all resource pools of the one or more resource pools on the i-th carrier may be configured by the second terminal, which may mean that the first terminal receives fourth configuration information transmitted by the second terminal, the fourth configuration information includes all resource pools on each of the N carriers, and the i-th carrier is any one of the N carriers. Further, the second terminal transmitting the fourth configuration information may be the second terminal transmitting the fourth configuration information to the first terminal after receiving the fourth configuration information transmitted by a second network device in a cell in which the second terminal is located. For example, when the second network device learns that the second terminal and the first terminal are in sidelink communication, the second network device may transmit the fourth configuration information to the second terminal, and the second terminal may transmit the fourth configuration information to the first terminal. Further, if the all resource pools on each of the N carriers are configured by the second terminal, the first terminal may further transmit related information of the all resource pools on each of the N carriers to the first network device.

The one or more specified resource pools of the one or more resource pools on the i-th carrier are configured by a network device, or determined by the first terminal, or configured by a second terminal, or specified by a protocol, or default.

Optionally, the one or more specified resource pools of the one or more resource pools on the i-th carrier may be transmitted to the first terminal by a first network device of a cell in which the first terminal is located, the specific description of the first network device is the same as that of the above embodiments, which will not be repeatedly described. For example, the one or more specified resource pools of the one or more resource pools on the i-th carrier may be configured by the first network device through fifth configuration information, and the fifth configuration information may include an identifier of each of the N carriers and related information of one or more specified resource pools on each carrier; and the i-th carrier is any one of N carriers. Related information of any specified resource pool may be an index number, a serial number or an identifier of the specified resource pool. The fifth configuration information may be carried by one of: an RRC signaling, DCI, an MAC CE, or the like.

Optionally, the one or more specified resource pools of the one or more resource pools on the i-th carrier may be specified by the protocol, for example, serial numbers or index numbers or identifiers of the one or more specified resource pools may be configured in the protocol.

Optionally, the one or more specified resource pools of the one or more resource pools on the i-th carrier are default, for example, serial numbers of one or more default resource pools corresponding to each of the N carriers may be preset in the system, and the one or more default resource pools may be used as the specified resource pools.

Optionally, in a case where the one or more specified resource pools of the one or more resource pools on the i-th carrier are determined by the first terminal, there is a second mapping relationship between the one or more specified resource pools of the one or more resource pools on the i-th carrier and a second parameter; where the second parameter may be a service-related parameter. Further, since the i-th carrier is any one of the N carriers, there are corresponding second mapping relationships between all the specified resource pools on each carrier and the second parameter, and the first terminal may determine the specified resource pools on each carrier. Accordingly, the first terminal may further transmit related information of the specified resource pools on each of the N carriers to the first network device.

The second mapping relationship may be any one of a second set of mapping relationships. The second set of mapping relationships may include: related information of the one or more resource pools on each of the N carriers, and a mapping relationship between each resource pool on each carrier and a candidate value of the second parameter. That is, according to a current value of the second parameter, one mapping relationship may be determined from the second set of mapping relationships as the second mapping relationship.

The second parameter includes at least one of: related information of a service, quality of service (QOS), a layer 2 (L2) identifier, a transmission profile, a priority, a logical channel identifier, or a logical channel. The related information of the service includes at least one of: a name of the service or an identifier of the service.

For example, assume that the second parameter is the name of the service, the second set of mapping relationships may include: a mapping relationship between a name of service 1 and resource pool 1 on the i-th carrier, a mapping relationship between a name of service 2 and resource pool 2 on the i-th carrier, a mapping relationship between a name of service 3 and resource pool 1 on the i+1-th carrier, or the like. If the current value of the second parameter is the name of service 1, the second mapping relationship is a mapping relationship between the name of service 1 and resource pool 1 of the i-th carrier. It should be understood that the above description is exemplary using the i-th carrier as an example, and the processing of other carriers is the same as that of the i-th carrier, which will not be repeated here.

Optionally, the method further includes: receiving, by the first terminal, first configuration information transmitted by the second terminal; where the first configuration information includes related information of the one or more specified resource pools of the one or more resource pools on the i-th carrier. The related information of the specified resource pools may exemplarily refer to any one of serial numbers, index numbers and identifier of the specified resource pools, which is not exhaustive enumeration here. The i-th carrier is any one of the N carriers, and the first configuration information may include related information of the one or more specified resource pools of the one or more resource pools on each of the N carriers, but details will not be repeatedly described. Accordingly, the first terminal may further transmit the related information of the one or more specified resource pools of the one or more resource pools on each of the N carriers to the first network device.

The second terminal may arbitrarily specify one resource pool as the above specified resource pool. Optionally, the second terminal may select the specified resource pool. Exemplarily, the one or more specified resource pools of the one or more resource pools on the i-th carrier include at least one of: a resource pool in which a resource monitored by the second terminal on the i-th carrier is located; or a resource pool in which a resource whose interference value less than a preset interference threshold value of one or more resources monitored by the second terminal on the i-th carrier is located. The second terminal may have monitoring resources on the N carriers, and accordingly, the second terminal may take the resource pools in which the resources monitored by the second terminal on each of the N carriers are located as the one or more specified resource pools of the one or more resource pools on the carrier. Further, the second terminal may obtain an interference value of each resource in a process of monitoring one or more resources currently, select a resource pool in which one resource with a minimum interference value in resources whose interference values are less than the preset interference threshold value is located from the one or more resources as the specified resource pool, or select resource pools in which all resources whose interference values are less than the preset interference threshold values are located from the one or more resources as the specified resource pools.

Based on the above description, it can be seen that a number of the at least part of one or more resource pools on the i-th carrier may be one or multiple. A processing manner of the number of the at least part of one or more resource pools on the i-th carrier being one may be different from that of the number of the at least part of one or more resource pools on the i-th carrier being multiple, and details will be described respectively below.

The operation of the first terminal determining the first reference value of the i-th carrier based on the values of the first parameters respectively corresponding to the at least part of one or more resource pools on the i-th carrier includes: in a case where a number of the at least part of one or more resource pools on the i-th carrier is 1, taking a value of a first parameter corresponding to the at least part of one or more resource pools on the i-th carrier as the first reference value of the i-th carrier.

That is, regardless of whether base on the at least part of one or more resource pools on the i-th carrier being all resource pools or specified resource pools, as long as the number of the at least part of one or more resource pools on the i-th carrier is 1, the first terminal takes the value of the first parameter corresponding to the one resource pool the i-th carrier as the first reference value of the i-th carrier. For example, the at least part of one or more resource pools on the i-th carrier is a unique resource pool, which is referred to as a resource pool A, the first reference value of the i-th carrier is exemplarily a value of a first parameter of the resource pool A on the i-th carrier.

It should be noted that the first reference value of the i-th carrier may be exemplarily referred to as a value of a reference of a CBR of the i-th carrier, a reference value of the CBR of the i-th carrier, or the like, or may be directly referred to as a value of the CBR of the i-th carrier, which is not exhaustive enumeration here. As long as it can indicate a resource usage status on the i-th carrier, it is within the protection scope of the present embodiments.

The operation of the first terminal determining the first reference value of the i-th carrier based on the values of the first parameters respectively corresponding to the at least part of one or more resource pools on the i-th carrier includes: in a case where a number of the at least part of one or more resource pools on the i-th carrier is greater than 1, performing, by the first terminal based on a target mode, processing on the values of the first parameters respectively corresponding to the at least part of one or more resource pools on the i-th carrier, to obtain the first reference value of the i-th carrier; where the target mode is configured by a network device, or determined by the first terminal, or configured by a second terminal, or specified by a protocol.

For the target mode, a same target mode may be used in a case where the at least part of one or more resource pools on any one of the N carriers is greater than one. In the present implementation, the processing of the i-th carrier will be mainly described as an example, and the processing manners of other carriers other than the i-th carrier in the N carriers will not be described in detail.

Here, the target mode may be specified by the protocol, that is, the first terminal may perform processing in a unique target mode specified by the protocol.

The target mode may be configured by the network device. The network device may refer to a first network device of a cell in which the first terminal is located, and the first network device is an access network device. The access network device may be any one of a base station, an eNB, a gNB, or the like, which will not be exhaustive enumeration here. It should be noted that the first network device configuring the target mode for the first terminal may be: selecting one of multiple candidate modes as the target mode and configuring it for the first terminal; or having only one target mode itself and directly configuring the target mode for the first terminal.

The target mode may be configured by the second terminal, and the second terminal may select any one of multiple candidate modes and configure for the first terminal; or have only one target mode itself and directly configure the target mode for the first terminal.

The target mode may be determined by the first terminal itself, and the first terminal may select any one of multiple candidate modes as the target mode, or have only one target mode itself and directly determine to use the target mode.

Exemplarily, the above multiple candidate modes may include at least one of: a candidate mode 1, which takes one of values of first parameters respectively corresponding to one or more resource pools on a carrier as a first numerical value; or a candidate mode 2, which performs calculation based on the values of the first parameters respectively corresponding to the one or more resource pools on the carrier, to obtain the first numerical value.

More specifically, the candidate mode 1 may include at least one of: a candidate mode 1-1, which takes a maximum value in the values of the first parameters respectively corresponding to the one or more resource pools on the carrier as the first numerical value; a candidate mode 1-2, which takes a minimum value in the values of the first parameters respectively corresponding to the one or more resource pools on the carrier as the first numerical value; or a candidate mode 1-3, which takes an arbitrary value in the values of the first parameters respectively corresponding to the one or more resource pools on the carrier as the first numerical value.

The candidate mode 2 may exemplarily include: a candidate mode 2-1, which performs average calculation on the values of the first parameters respectively corresponding to the one or more resource pools on the i-th carrier, to obtain the first numerical value.

Further, in addition to the above candidate mode 2-1, the candidate mode 2 may further include at least one of: a candidate mode 2-2, which performs weighted calculation on the values of the first parameters respectively corresponding to the one or more resource pools based on weighted values respectively corresponding the one or more resource pools on the carries, and then performs average calculation based on values of first parameters on which the weighted calculation is performed respectively corresponding to the one or more resource pools, to obtain the first numerical value. Here, in the weighted calculation, the weight values corresponding to different resource pools on the carrier may be same or different; and a weight value corresponding to each resource pool may be preset, or configured by the network device; or a candidate mode 2-3, which performs calculation on the values of the first parameters respectively corresponding to the one or more resource pools on the carrier by adopting a preset formula, to obtain the first numerical value. The preset formula may be preset according to actual conditions or configured by the network device, and the preset formula is not limited in the present embodiment. It should be understood that the above description is merely an exemplary description, and in actual processing, there may be more calculation manners, and as long as the calculation manners use the values of the first parameter respectively corresponding to the resource pools, they are within the protection scope of the present embodiment, but without exhaustive enumeration.

Further, there is a first mapping relationship between the target mode and a second parameter, and the second parameter is a service-related parameter. Here, the first mapping relationship is one of a first set of mapping relationships, and a manner of determining the first mapping relationship may be that the first mapping relationship is determines based on a preset first set of mapping relationships and a current value of the second parameter.

The second parameter includes at least one of: related information of a service, quality of service (QOS), a layer 2 (L2) identifier, a transmission profile, a priority, a logical channel identifier, or a logical channel. The related information of the service includes at least one of: a name of the service or an identifier of the service. The current value of the second parameter, that is, a current value of the second parameter corresponding to a current service of the first terminal, for example, the service currently used by the first terminal is service 1, that is, the current value of the name of the service is a name of service 1, and the details will not be repeatedly described.

The first set of mapping relationships may include: one or more candidate values of the second parameter, and a mapping relationship between each of the one or more candidate values and one of the multiple candidate modes.

Taking the second parameter being an identifier of the service as an example, the first set of mapping relationships will be exemplarily described. the candidate mode 1-1 and an identifier of service 1 may have a mapping relationship, the candidate mode 1-2 and an identifier of service 2 have a mapping relationship, the candidate mode 1-3 and an identifier of service 3 may have a mapping relationship, and the candidate mode 2 and an identifier of service 4 may have a mapping relationship. If a current value of the second parameter is the identifier of service 3, it is determined from the first set of mapping relationships that the mapping relationship between the candidate mode 1-3 and the identifier of service 3 may be the first mapping relationship.

It should also be understood that if the target mode is configured by a first network device, the first network device may determine the first mapping relationship according to the first set of mapping relationships and the current value of the second parameter corresponding to a current service of the first terminal, and take a candidate mode included in the first mapping relationship as the target mode. If the target mode is configured by the second terminal, the second terminal may also determine the first mapping relationship according to the first set of mapping relationships and the current value of the second parameter corresponding to the current service of the first terminal, and take the candidate mode included in the first mapping relationship as the target mode. If the target mode is determined by the first terminal, the first terminal may determine the first mapping relationship according to the first set of mapping relationships and the current value of the second parameter corresponding to the current service of itself, and take the candidate mode included in the first mapping relationship as the target mode.

It should be noted that if the target mode is determined by the first terminal, or configured by the second terminal, the first terminal may further transmit related information of the target mode to the first network device. The related information of the target mode may exemplarily be an identifier, a serial number, an index number, or the like of the target mode.

In a side of the first terminal, the values of the first parameters respectively corresponding to the at least part of one or more resource pools on the i-th carrier may be processed according to the target mode, to obtain the first reference value of the i-th carrier.

The target mode may include one of: taking one of the values of the first parameters respectively corresponding to the at least part of one or more resource pools on the i-th carrier as the first reference value of the i-th carrier; and performing calculation on the values of the first parameters respectively corresponding to the at least part of one or more resource pools on the i-th carrier, to obtain the first reference value of the i-th carrier.

The one of the values of the first parameters respectively corresponding to the at least part of one or more resource pools on the i-th carrier includes one of: a maximum value in the values of the first parameters respectively corresponding to the at least part of one or more resource pools on the i-th carrier; a minimum value in the values of the first parameters respectively corresponding to the at least part of one or more resource pools on the i-th carrier; and an arbitrary value in the values of the first parameters respectively corresponding to the at least part of one or more resource pools on the i-th carrier.

In an example, the first terminal selects a maximum first value of first parameters from the values of the first parameters respectively corresponding to the at least part of one or more resource pools on the i-th carrier, and directly takes the maximum first value as the first reference value of the i-th carrier.

In an example, the first terminal selects a maximum first value of first parameters from the values of the first parameters respectively corresponding to the at least part of one or more resource pools on the i-th carrier, and directly takes the maximum first value as the first reference value of the i-th carrier.

In one example, the first terminal selects any value from the values of the first parameters respectively corresponding to the at least part of one or more resource pools on the i-th carrier, and directly takes the value as the first reference value of the i-th carrier.

In an example, the operation of performing calculation on the values of the first parameters respectively corresponding to the at least part of one or more resource pools on the i-th carrier, to obtain the first reference value of the i-th carrier includes: performing average calculation on the values of the first parameters respectively corresponding to the at least part of one or more resource pools on the i-th carrier, to obtain the first reference value of the i-th carrier.

In an example, regarding of the operation of performing calculation on the values of the first parameters respectively corresponding to the at least part of one or more resource pools on the i-th carrier, to obtain the first reference value of the i-th carrier, in addition to the above manner of average calculation, there may be other manners. For example, weighted calculation is performed on the values of the first parameters respectively corresponding to the at least part of one or more resource pools on the i-th carrier according to weighted values respectively corresponding to the at least part of one or more resource pools on the i-th carrier, to obtain the first reference value of the i-th carrier. Alternatively, by adopting a preset formula, calculation is performed on the values of the first parameters respectively corresponding to the at least part of one or more resource pools on the i-th carrier, to obtain the first reference value of the i-th carrier. Here, in the weighted calculation, weight values corresponding to different resource pools may be same or different; and a weight value corresponding to each resource pool may be preset, or configured by the network device. The preset formula may be preset according to actual conditions or configured by the network device, and the preset formula is not limited in the present embodiment. It should be understood that the above description is merely an exemplary description, and in actual processing, there may be more calculation manners, and as long as the calculation manners use the values of the first parameter respectively corresponding to the resource pools, they are within the protection scope of the present embodiment, but without exhaustive enumeration.

It should be understood that, in the N carriers, a number of resource pools on different carriers may be same or different. When processing is performed on a certain carrier, according to the number of the at least part of one or more resource pools on the carrier being 1 or greater than 1, processing is performed by adopting the above different manners, to obtain the first reference value corresponding to the carrier.

The operation of determining the first transmission resource based on the first reference value of each of the N carriers includes:
selecting, by the first terminal based on the first reference value of each of the N carriers, K first available carriers whose first reference values are less than a first preset threshold, where K is a positive integer less than or equal to N; and determining, by the first terminal from the K first available carriers, a first carrier as the first transmission resource.

The first preset threshold value may be preset according to actual conditions, or configured by the network device, or determined by the first terminal, or configured by the second terminal, and the specific value thereof is not limited here. K may be an integer greater than or equal to 1 and less than or equal to N.

The processing manner of the first terminal determining, from the K first available carriers, the first carrier as the first transmission resource may include one of the following.

In a processing manner, the first carrier may be selected by the first terminal itself. Exemplarily, the first terminal arbitrarily selects one available carrier from the K first available carriers as the first carrier; and takes the first carrier as the first transmission resource. That is, since the K first available carriers are carriers currently available for the first terminal, the first terminal may arbitrarily select one of the K first available carriers as the first carrier, takes the first carrier as the first transmission resource, and then perform data transmission on the first transmission resource. Here, data transmission being performed on the first transmission resource may mean that: the first terminal performs data transmission on the first transmission resource to the second terminal. The data may exemplarily refer to service data.

In a processing manner, the first carrier may be selected by the first terminal itself. Exemplarily, the first terminal selects an available carrier with a minimum first reference value from the K first available carriers as the first carrier, and takes the first carrier as the first transmission resource. That is, after the first terminal determines the K first available carriers, the first terminal selects, based on the first reference values respectively corresponding to the K first available carriers, the available carrier with the minimum first reference value from the K first available carriers as the first carrier, and then takes the first carrier as the first transmission resource to perform data transmission on the first transmission resource. Here, the description of data transmission being performed on the first transmission resource is the same as the above processing method, and the description will not be repeated here.

In a processing manner, the first carrier may be obtained by the first terminal through processing according to related information of the K first available carriers and/or second information transmitted by the second terminal. Exemplarily, the first terminal transmits first information to the second terminal, where the first information is used to indicate that the second terminal transmits a suggested carrier, and the first terminal receives second information transmitted by the second terminal, where the second information includes a carrier suggested by the second terminal; and the first terminal determines the first carrier according to the related information of the K first available carriers and/or the second information, and takes the first carrier as the first transmission resource.

The first information may exemplarily include information indicating that the second terminal transmits the suggested carrier. Further, the first information may include the related information of the K first available carriers. The related information of the K first available carriers may include: an identifier of each of the K first available carriers. On the basis of the foregoing, the related information of the K first available carriers may further include: a first reference value of each of the K first available carriers.

The carrier suggested by the second terminal is a carrier used by the second terminal. Here, the carrier used by the second terminal may refer to a carrier currently monitored by the second terminal, or may refer to a carrier currently used by the second terminal for data transmission.

Exemplarily, the carrier used by the second terminal includes at least one of: a carrier used by the second terminal on a sidelink with a third device; or a carrier used by the second terminal on a link with a network device.

The third device is different from the first terminal, and the carrier used on the sidelink between the second terminal and the third device may include: a carrier monitored on the sidelink between the second terminal and the third device, or a carrier used for data transmission on the sidelink between the second terminal and the third device. The carrier used on the link between the second terminal and the network device may be a carrier used on the link between the second terminal and a second network device. The second network device exemplarily refers to an access network device of a cell in which the second terminal is located; and the second network device may be the same as or different from the first network device, which is not limited here. The carrier used on the link between the second terminal and the second network device may be a carrier monitored on the link between the second terminal and the second network device, or may be a carrier used for data transmission on the link between the second terminal and the second network device.

The carrier suggested by the second terminal included in the second information may be different depending on the difference of the first information, that is, manners of the second terminal determining its suggested carrier may be different depending on the difference of the first information. Accordingly, specific processing of the first terminal determining the first carrier according to the related information of the K first available carriers and/or the second information and taking the first carrier as the first transmission resource may be different, and exemplary illustrations will be described below.

In an example, the first information includes information indicating that the second terminal transmits the suggested carrier. In this case, the operation of the second terminal determining its suggested carrier may include: the second terminal taking the carrier used by the second terminal as the suggested carrier. Here, the definition of the carrier used by the second terminal is the same as foregoing, and the description will not be repeated here.

The operation of the first terminal determining the first carrier according to the related information of the K first available carriers and/or the second information and taking the first carrier as the first transmission resource may include: in a case where the first terminal determines that the carrier suggested by the second terminal included in the second information does not include any one of the K first available carriers, determining, by the first terminal, the first carrier from the K first available carriers according to the related information of the K first available carriers, and takes the first carrier as the first transmission resource.

A manner of the first terminal determining whether the K first available carriers are included in the carrier suggested by the second terminal included in the second information may be that: the first terminal determines whether identifiers (or serial numbers, or index numbers) of the K first available carriers are included in identifiers (or serial numbers, or index numbers) respectively corresponding to one or more carriers suggested by the second terminal included in the second information; if so, it is determined that at least one of the K first available carriers is included in the carrier suggested by the second terminal included in the second information, otherwise, it is determined that any one of the K first available carriers is not included in the carrier suggested by the second terminal included in the second information.

The related information of the K first available carriers may refer to an identifier (or a serial number, or an index number) of each of the K first available carriers. The operation of the first terminal determining the first carrier from the K first available carriers according to the related information of the K first available carriers may exemplarily be that the first terminal arbitrarily selects one available carrier from the K first available carriers as the first carrier according to the related information of the K first available carriers.

The related information of the K first available carriers may refer to a first reference value of each of the K first available carriers. The operation of the first terminal determining the first carrier from the K first available carriers according to the related information of the K first available carriers may exemplarily be that the first terminal selects, from the K first available carriers, a first available carrier with a minimum first reference value as the first carrier according to the first reference value of each of the K first available carriers.

In another example, the first information includes information indicating that the second terminal transmits the suggested carrier. In this case, the operation of the second terminal determining its suggested carrier may include: the second terminal taking the carrier used by the second terminal as the suggested carrier. Here, the definition of the carrier used by the second terminal is the same as foregoing, and the description will not be repeated here.

The operation of the first terminal determining the first carrier according to the related information of the K first available carriers and/or the second information and taking the first carrier as the first transmission resource may include: in a case where it is determined, according to the related information of the K first available carriers, that the carrier suggested by the second terminal included in the second information is the same as one or more fourth available carriers in the K first available carriers, determining, by the first terminal, the first carrier from the one or more fourth available carriers, and taking the first carrier as the first transmission resource.

Here, the related information of the K first available carriers may include the identifier (or the serial number, or the index number) of each of the K first available carriers. The operation of determining, according to the related information of the K first available carriers, that the carrier suggested by the second terminal included in the second information is the same as one or more fourth available carriers in the K first available carriers may include: determining, according to the identifiers (or the serial numbers, or the index numbers) of the K first available carriers, whether the carrier suggested by the second terminal included in the second information is the same as one or more available carriers in the K first available carriers, and if same, taking the same one or more available carriers as the one or more fourth available carriers.

In a case where a number of the fourth available carriers is one, the operation of the first terminal determining the first carrier from the one or more fourth available carriers may include: directly taking, by the first terminal, the fourth available carrier as the first carrier. In a case where the number of the fourth available carriers is multiple, the operation of the first terminal determining the first carrier from the one or more fourth available carriers may include: arbitrarily selecting, by the first terminal, one carrier from the multiple fourth available carriers as the first carrier; or selecting, by the first terminal, one carrier with a minimum first reference value from the multiple fourth available carriers as the first carrier.

That is, in a case where there is an intersection between the K first available carriers and the carrier suggested by the second terminal, one or more available carriers included in the intersection are taken as the one or more fourth available carriers; and one of the one or more fourth available carriers is directly taken as the first carrier. By adopting the solution provided in the present example for selecting the first carrier, it is possible to cause that the first carrier selected by the first terminal may be one of the carriers currently used by the second terminal. In this way, it can be ensured that the second terminal monitors as few carriers as possible, so that the second terminal may not be required to have higher capabilities, and power consumption of the second terminal can be reduced as well.

In yet another example, the first information includes the related information of the K first available carriers. In this case, the operation of the second terminal determining the suggested carrier may include: determining, by the second terminal, the carriers used by itself, and selecting, from the carriers used by itself, one or more carriers same as the K first available carriers as the suggested one or more carriers according to the related information of the K first available carriers. Here, the definition of the carrier used by the second terminal is the same as foregoing, and the description will not be repeated here.

The operation of the first terminal determining the first carrier according to the related information of the K first available carriers and/or the second information and taking the first carrier as the first transmission resource may include: determining, by the first terminal, the first carrier from the carriers suggested by the second terminal included in the second information, and taking the first carrier as the first transmission resource.

The number of the carriers suggested by the second terminal may be one or multiple.

In a case where the number of the carriers suggested by the second terminal is one, the operation of the first terminal determining the first carrier from the carriers suggested by the second terminal included in the second information may exemplarily be that the first terminal may directly takes one carrier suggested by the second terminal included in the second information as the first carrier.

In a case where the number of the carriers suggested by the second terminal is multiple, the operation of the first terminal determining the first carrier from the carriers suggested by the second terminal included in the second information may exemplarily be that the first terminal arbitrarily selects one carrier from the multiple carriers suggested by the second terminal included in the second information as the first carrier; or the first terminal selects a carrier with a minimum first reference value from the multiple carriers suggested by the second terminal included in the second information as the first carrier.

By adopting the above implementations, the first terminal may complete primary selection of the transmission resource, and take the first carrier as a primary first transmission resource. The processing solutions provided by the present embodiment is that the first terminal determines the first reference value of each of the N carriers based on the values of the first parameters respectively corresponding to the one or more resource pools on each of the N carriers, and determines the first transmission resource based on the first reference value of each of the N carriers, which enables to achieve that the first reference value of each carrier is determined based on the values of the first parameters of the resource pools on each carrier, in a sidelink carrier aggregation scenario. In this way, each carrier has a more accurate first reference value in the sidelink carrier aggregation scenario, and the processing of carrier selection in the sidelink carrier aggregation scenario becomes more accurate, which also ensure that the transmission resource that is more suitable for the current resource usage state is selected for data transmission, thereby ensuring the communication efficiency of the system.

In a possible implementation, after completing the primary selection of transmission resource, the first terminal performs transmission resource reselection while using a certain carrier for data transmission. The present implementation is described with respect to the processing of the first terminal performing the transmission resource reselection.

The method further includes: determining, by the first terminal, a reselected first transmission resource based on a first reference value of a second carrier and/or values of first parameters respectively corresponding to one or more resource pools on the second carrier; where the second carrier is a carrier currently used by the first terminal for data transmission, and the second carrier is one of the N carriers.

Different from the above implementations, before performing the present implementation, the carrier currently used by the first terminal for data transmission is the second carrier.

Here, the second carrier and the first carrier in the above embodiments may be the same or different. The first carrier selected in the above embodiments may refer to that the first terminal selects the first carrier as the first transmission resource when the first terminal performs the primary selection of transmission resource. In the present implementation, the second carrier is the same as the first carrier when the processing of transmission resource reselection is performed for the first time after the first terminal performs the primary selection; and the second carrier and the first carrier may be the same or different when the processing of the transmission resource reselection is performed after the first terminal performs the processing of the transmission resource reselection one or multiple times.

The first reference value of the second carrier is determined based on values of first parameters respectively corresponding to the at least part of one or more resource pools on the second carrier.

The at least part of one or more resource pools on the second carrier includes one of: all resource pools of the at least part of one or more resource pools on the second carrier; one or more specified resource pools of the at least part of one or more resource pools on the second carrier; and a first resource pool on the second carrier; where the first resource pool is a resource pool in which a resource currently used by the first terminal for data transmission is located.

The first resource pool on the second carrier may exemplarily refer to a resource pool in which a resource currently used by the first terminal for data transmission on the second carrier is located, or a resource pool in which a resource currently used by the first terminal for a specific sidelink process (SL Process) on the second carrier is located.

The all resource pools of the at least part of one or more resource pools on the second carrier may be configured by a network device, or determined by the first terminal, or configured by a second terminal. The network device may exemplarily refer to a first network device, and the first network device may be an access network device of a cell in which the first terminal is located, for example, may be any one of a base station, a gNB, an eNB, or the like of the cell in which the first terminal is located. Since the second carrier is one of the N carriers which are used for performing the primary selection of the resource in the above implementations, a determining manner of the all resource pools of the at least part of one or more resource pools on the second carrier is the same as that of the i-th carrier in the above implementations, and thus details will not be described here.

The one or more specified resource pools of the at least part of one or more resource pools on the second carrier are configured by the network device, or determined by the first terminal, or configured by a second terminal. There is a second mapping relationship between a specified resource pool on the second carrier and a second parameter; and the second parameter is a service-related parameter.

The method further includes: receiving, by the first terminal, second configuration information transmitted by the second terminal; where the second configuration information includes related information of the specified resource pool on the second carrier. The specified resource pool on the second carrier includes at least one of: a resource pool in which a resource monitored by the second terminal on the second carrier is located; or a resource pool in which a resource whose interference value less than a preset interference threshold value of one or more resources monitored by the second terminal on the second carrier is located. The second terminal may have monitoring resources on the second carrier, and accordingly, the second terminal may take a resource pool in which the resource monitored by the second terminal on the second carrier is located as the specified resource pool. Further, the second terminal may obtain an interference value of each resource on the second carrier in a process of monitoring one or more resources currently, select a resource pool in which one resource with a minimum interference value in resources whose interference values are less than the preset interference threshold value is located from the one or more resources as the specified resource pool, alternatively, select resource pools in which all resources whose interference values are less than the preset interference threshold values are located from the one or more resources as the specified resource pools. The second configuration information may be transmitted by the second terminal to the first terminal on the SL via the second carrier.

Since the second carrier is one of the N carriers which are used for performing the primary selection of the resource in the above implementations, the specific configuration or determination manner of the specified resource pools of the second carrier is the same as the configuration or determination manner of the specified resource pools of the i-th carrier in the above implementations, and thus the description will not be repeated here.

A value of a first parameter corresponding to each resource pool in the one or more resource pools on the second carrier is measured by the first terminal or a default value. Here, the manner of the first terminal obtaining the values of the first parameters respectively corresponding to the one or more resource pools on the second carrier is the same as the manner of obtaining the value of the first parameter corresponding to the j-th resource pool on the i-th carrier in the above embodiments, and the description will not be repeated here.

Since the specific manner of determining the first reference value of the second carrier is the same as the specific manner of determining the corresponding first reference value of the i-th carrier by the first terminal, and thus the description will not be repeated here.

Exemplarily, the processing manner of the first terminal determining the reselected first transmission resource based on the first reference value of the second carrier and/or the values of the first parameters respectively corresponding to the one or more resource pools on the second carrier may include the followings, respectively.

Manner 1, in a case where the first reference value of the second carrier is less than a second preset threshold value and/or a value of a first parameter of a first resource pool on the second carrier is less than a third preset threshold value, the first terminal takes the second carrier as the reselected first transmission resource.

Optionally, in a case where the first reference value of the second carrier is less than the second preset threshold value, the first terminal takes the second carrier as the reselected first transmission resource.

The second preset threshold value may be preset according to actual conditions, configured by a first network device, determined by the first terminal, or configured by a second terminal. It is preset according to the actual conditions, or configured by the first network device, or determined by the first terminal, or configured by the second terminal. A value of the second preset threshold value may be the same as or different from the above first preset threshold value.

That is, as long as the first reference value of the second carrier currently used for data transmission is less than the second preset threshold value, the second carrier may be taken as the reselected first transmission resource.

Optionally, in a case where the value of the first parameter of the first resource pool on the second carrier is less than the third preset threshold value, the first terminal takes the second carrier as the reselected first transmission resource.

The third preset threshold value may be preset according to actual conditions, configured by a first network device, determined by the first terminal, or configured by a second terminal. A value of the third preset threshold value may be the same as or different from any one of the second preset threshold value and first preset threshold value. In a case where the third preset threshold value is different from the second preset threshold value, the third preset threshold value may be less than the second preset threshold value, or greater than the second preset threshold value.

That is, as long as the value of the first parameter of the first resource pool on the second carrier currently used for data transmission is less than the third preset threshold value, the second carrier may be taken as the reselected first transmission resource.

Further, the first resource pool on the second carrier may be maintained as the resource pool currently used for data transmission. In addition, the method may further include: selecting a first resource from the first resource pool for data transmission, and a manner of selecting the first resource is not limited in the present embodiments.

Optionally, in a case where the first reference value of the second carrier is less than a second preset threshold value and the value of the first parameter of the first resource pool on the second carrier is less than the third preset threshold value, the first terminal takes the second carrier as the reselected first transmission resource. Here, the description of the third preset threshold value and second preset threshold value is the same as that described above, which will not be repeatedly described.

In this manner, in a process of the first terminal using the second carrier as a previously selected transmission resource for data transmission, in a case where the first reference value of the second carrier is less than the second preset threshold value and/or the value of the first parameter of the first resource pool on the second carrier is less than the third preset threshold value, the first terminal takes the second carrier as the reselected first transmission resource. Further, the first resource pool on the second carrier may be maintained as the resource pool currently used for data transmission. In addition, the method may further include: selecting the first resource from the first resource pool for data transmission, and the manner of selecting the first resource is not limited in the present embodiments.

Manner 2: in a case where the first reference value of the second carrier is not less than a second preset threshold value, the first terminal selects a third carrier and takes the third carrier as the reselected first transmission resource; where the third carrier is different from the second carrier.

The operation of the first terminal selecting the third carrier includes: selecting, by the first terminal based on first reference values respectively corresponding to multiple carriers, one or more second available carriers whose first reference values are less than a first preset threshold value, where the multiple carriers do not include the second carrier; and determining, by the first terminal, the third carrier from the one or more second available carriers. Here, the multiple carriers may be carriers other than the second carrier in all carriers currently configured for the first terminal, that is, carriers other than the second carrier in the N carriers.

Optionally, the operation of the first terminal determining the third carrier from the one or more second available carriers may be one of: selecting, by the first terminal, any one of the one or more second available carriers as the third carrier; and selecting, by the first terminal, a third carrier with a minimum first reference value from the one or more second available carriers.

Exemplarily, if a number of the second available carriers is one, the second available carrier may be directly taken as the third carrier; and if the number of the second available carriers is two or more, the first terminal selects any one of the multiple second available carriers as the third carrier; or the first terminal selects, from the multiple second available carriers, a second available carrier with the minimum first reference value as the third carrier.

Optionally, the operation of the first terminal determining the third carrier from the one or more second available carriers includes: transmitting, by the first terminal, third information to the second terminal, where the third information is used to indicate that the second terminal transmits a suggested carrier; receiving, by the first terminal, fourth information transmitted by the second terminal, where the fourth information includes a carrier suggested by the second terminal; and determining, by the first terminal, the third carrier based on related information of the one or more second available carriers and/or the fourth information.

The third information may exemplarily include information indicating that the second terminal transmits the suggested carrier. Further, the third information includes related information of the one or more second available carriers. The related information of the one or more second available carriers may include: an identifier of each of the one or more second available carriers. On the basis of the foregoing, the related information of the one or more second available carriers may further include: a first reference value of each of the one or more second available carriers.

The carrier suggested by the second terminal is a carrier used by the second terminal. Here, the carrier used by the second terminal may refer to a carrier currently monitored by the second terminal, or may refer to a carrier currently used by the second terminal for data transmission. The description of the carrier suggested by the second terminal is the same as that of the above embodiments, and thus the description will not be repeated here.

The exemplary description of the first terminal determining the third carrier based on the related information of the one or more second available carriers and/or the fourth information includes the followings.

In an example, the third information includes information indicating that the second terminal transmits the suggested carrier. In this case, the operation of the second terminal determining the carrier suggested by the second terminal may include: the second terminal taking the carrier used by the second terminal as the suggested carrier. Here, the definition of the carrier used by the second terminal is the same as foregoing, and the description will not be repeated here.

The operation of the first terminal determining the third carrier based on the related information of the one or more second available carriers and/or the fourth information may include: in a case where the first terminal determines that the carrier suggested by the second terminal included in the fourth information does not include any one of the one or more second available carriers, determining, by the first terminal, the third carrier from the one or more second available carriers according to the related information of the one or more second available carriers.

The manner of the first terminal determining whether the one or more second available carriers are included in the carrier suggested by the second terminal included in the fourth information may be that: the first terminal determines whether identifiers (or serial numbers, or index numbers) of the one or more second available carriers are included in the identifiers (or serial numbers, or index numbers) respectively corresponding to one or more carriers suggested by the second terminal included in the second information; if so, it is determined that at least one of the one or more second available carriers is included in the carrier suggested by the second terminal included in the second information, otherwise, it is determined that any one of the one or more second available carriers is not included in the carrier suggested by the second terminal included in the second information.

The related information of the one or more second available carriers may refer to an identifier (or a serial number, or an index number) of each of the one or more second available carriers. The operation of the first terminal determining the third carrier from the one or more second available carriers according to the related information of the one or more second available carriers may exemplarily be that: the first terminal arbitrarily selects one available carrier from the one or more second available carriers as the first carrier according to the related information of the one or more second available carriers.

The related information of the one or more second available carriers may refer to a first reference value of each of the one or more second available carriers. The operation of the first terminal determining the third carrier from the one or more second available carriers according to the related information of the one or more second available carriers may exemplarily be that: the first terminal selects, from the one or more second available carriers, a second available carrier with a minimum first reference value as the third carrier according to the first reference value of each of the one or more second available carriers.

In another example, the third information includes information indicating that the second terminal transmits the suggested carrier. In this case, the operation of the second terminal determining the carrier suggested by the second terminal may include: the second terminal taking the carrier used by the second terminal as the suggested carrier. Here, the definition of the carrier used by the second terminal is the same as foregoing, and the description will not be repeated here.

The operation of the first terminal determining the third carrier based on the related information of the one or more second available carriers and/or the fourth information may include: in a case where it is determined, according to the related information of the one or more second available carriers, that the carrier suggested by the second terminal included in the second information is the same as one or more fifth available carriers in the one or more second available carriers, determining, by the first terminal, the third carrier from the one or more fifth available carriers. Here, the related information of the one or more second available carriers may include the identifier (or the serial number, or the index number) of each of the one or more second available carriers.

In a case where a number of the fifth available carriers is one, the operation of the first terminal determining the third carrier from the one or more fifth available carriers may include: directly taking, by the first terminal, the fifth available carrier as the third carrier. In a case where the number of the fifth available carriers is multiple, the operation of the first terminal determining the third carrier from the one or more fifth available carriers may include: arbitrarily selecting, by the first terminal, one carrier from the multiple fifth available carriers as the third carrier; or selecting, by the first terminal from the multiple fifth available carriers, a carrier with a minimum first reference value as the third carrier.

In yet another example, the first information includes the related information of the one or more second available carriers. In this case, the operation of the second terminal determining the carrier suggested by the second terminal may include: determining, by the second terminal, carriers used by itself, and selecting, from the used carriers, one or more carriers same as the one or more second available carriers as suggested one or more carriers according to the related information of the one or more second available carriers. Here, the definition of the carrier used by the second terminal is the same as foregoing, and the description will not be repeated here.

The operation of the first terminal determining the third carrier based on the related information of the one or more second available carriers and/or the fourth information may include: determining, by the first terminal, the third carrier from the carriers suggested by the second terminal included in the second information.

The number of the carrier suggested by the second terminal may be one or multiple. In a case where the number of the carrier suggested by the second terminal is one, the operation of the first terminal determining the first carrier from the carrier suggested by the second terminal included in the second information may exemplarily be that: the first terminal may directly takes one carrier suggested by the second terminal included in the second information as the third carrier. In a case where the number of the carrier suggested by the second terminal is multiple, the operation of the first terminal determining the third carrier from the carrier suggested by the second terminal included in the second information may exemplarily be that: the first terminal arbitrarily selects one carrier from multiple carriers suggested by the second terminal included in the second information as the third carrier; or the first terminal selects a carrier with a minimum first reference value from the multiple carriers suggested by the second terminal included in the second information as the third carrier.

In this manner, in addition to needing to determine based on the first reference value of the second carrier, the carrier is reselected in combination with first reference values of multiple other carriers. That is, in a case where the first reference value of the second carrier is not less than the second preset threshold value, the first terminal selects the one or more second available carriers whose first reference values are less than the first preset threshold value based on the first reference values respectively corresponding to the multiple carriers; the first terminal determines the third carrier from the one or more second available carriers; and the first terminal takes the third carrier as the reselected first transmission resource.

Manner 3: in a case where the first reference value of the second carrier is less than a second preset threshold value and a value of a first parameter of a first resource pool on the second carrier is not less than a third preset threshold value; the first terminal selects a third carrier and takes the third carrier as the reselected first transmission resource; where the third carrier is different from the second carrier.

The determining conditions of this manner is different from that of the Manner 2, and in this manner, although the first reference value of the second carrier is less than the second preset threshold value, the value of the first parameter of the first resource pool on the second carrier is not less than the third preset threshold value, and thus a new third carrier is reselected as the reselected first transmission resource.

The manner of selecting the third carrier is the same as that described in Manner 2, and the description will not be repeated here.

Manner 4: in a case where the first reference value of the second carrier is less than a second preset threshold value and/or a value of a first parameter of a first resource pool on the second carrier is less than a third preset threshold value, the first terminal takes the first resource pool on the second carrier as the reselected first transmission resource; where the first resource pool is a resource pool in which a resource currently used by the first terminal for data transmission is located.

Optionally, only whether the first reference value of the second carrier is less than the second preset threshold value may be determined, and if so, the first resource pool on the second carrier may be taken as the reselected first transmission resource. That is, before reselecting the first transmission resource, when the first terminal performs current data transmission in the first resource pool of the second carrier, if the condition that the first reference value of the second carrier is less than the second preset threshold value is met, the first resource pool on the second carrier may still be used as the reselected first transmission resource.

Optionally, on the basis that the first reference value of the second carrier is less than the second preset threshold value, whether the value of the first parameter of the first resource pool is less than the third preset threshold value is further determined, if so, the first terminal takes the first resource pool on the second carrier as the reselected first transmission resource.

Optionally, only whether the value of the first parameter of the first resource pool is less than the third preset threshold value may be determined, and if so, the first terminal takes the first resource pool on the second carrier as the reselected first transmission resource.

Manner 5: in a case where the first reference value of the second carrier is less than a second preset threshold value and a value of a first parameter of a first resource pool is not less than a third preset threshold value, the first terminal selects a second resource pool on the second carrier, where the second resource pool is one of one or more third resource pools on the second carrier other than the first resource pool; and the first terminal determines that the second resource pool on the second carrier is the reselected first transmission resource.

This manner different from Manner 4 is that, although the first reference value of the second carrier is also less than the second preset threshold value, instead of directly taking the first resource pool on the second carrier as the reselected first transmission resource, it is further determined whether the value of the first parameter of the first resource pool is less than the third preset threshold value, and if it is not less than the third preset threshold value, another resource pool, i.e., the second resource pool, is selected from the second carrier. Finally, the second resource pool on the second carrier is taken as the reselected first transmission resource.

The manner of selecting the second resource pool on the second carrier may include: selecting, from one or more third resource pools on the second carrier, a third resource pool with a minimum value of the first parameter as the second resource pool; or arbitrarily selecting one of the one or more third resource pools on the second carrier as the second resource pool.

Alternatively, a value of a first parameter of each of the one or more third resource pools is less than the third preset threshold value. That is, one or more third resource pools whose values of the first parameters are less than the third preset threshold value may be selected from the one or more resource pools on the second carrier in advance. Accordingly, the manner of selecting the second resource pool on the second carrier may include: selecting, from the one or more third resource pools on the second carrier, a third resource pool with a minimum value of the first parameter as the second resource pool; or arbitrarily selecting one of the one or more third resource pools on the second carrier as the second resource pool.

In this manner, in a process of the first terminal currently using the first resource pool on the second carrier for data transmission, in addition to needing to determine based on the first reference value of the second carrier and the value of the first parameter of the first resource pool, the transmission resource may be reselected in combination with the values of the first parameters of the one or more resource pools on the second carrier, that is, other resource pools on the second carrier may be preferentially selected as the reselected first transmission resource. In other words, in a case where the first reference value of the second carrier is less than the second preset threshold value and the value of the first parameter of the first resource pool is not less than the third preset threshold value, the first terminal selects the second resource pool on the second carrier; and takes the second resource pool on the second carrier as the reselected first transmission resource.

Manner 6: in a case where the first reference value of the second carrier is not less than a second preset threshold value and/or a value of a first parameter of a first resource pool is less than a third preset threshold value, the first terminal selects a second resource pool on the second carrier, where the second resource pool is one of one or more third resource pools on the second carrier other than the first resource pool; and the first terminal determines that the second resource pool on the second carrier is the reselected first transmission resource.

Optionally, the first terminal only determines whether the first reference value of the second carrier is less than the second preset threshold value; and in a case where the first reference value of the second carrier is not less than the second preset threshold value, the first terminal selects the second resource pool on the second carrier and takes the second resource pool on the second carrier as the reselected first transmission resource.

Optionally, the first terminal only determines whether the value of the first parameter of the first resource pool is less than the third preset threshold value; and in a case where the value of the first parameter of the first resource pool is less than the third preset threshold value, the first terminal selects the second resource pool on the second carrier and takes the second resource pool on the second carrier as the reselected first transmission resource.

Optionally, the first terminal determines whether the first reference value of the second carrier is less than the second preset threshold value firstly; in a case where the first reference value of the second carrier is not less than the second preset threshold value, then determines whether the value of the first parameter of the first resource pool is less than the third preset threshold value; and in a case where the value of the first parameter of the first resource pool is less than the third preset threshold value, the first terminal selects the second resource pool on the second carrier and takes the second resource pool on the second carrier as the reselected first transmission resource.

The above manner of selecting the second resource pool on the second carrier is the same as that in Manner 5, and the description will not be repeated here.

Manner 7: in a case where the first reference value of the second carrier is not less than a second preset threshold value and/or a value of a first parameter of a first resource pool is less than a third preset threshold value, the first terminal takes the first resource pool on the second carrier as the reselected first transmission resource; where the first resource pool is a resource pool in which a resource currently used by the first terminal for data transmission is located.

Optionally, the first terminal only determines whether the first reference value of the second carrier is less than the second preset threshold value; and in a case where the first reference value of the second carrier is not less than the second preset threshold value, the first terminal takes the first resource pool on the second carrier as the reselected first transmission resource.

Optionally, the first terminal only determines whether the value of the first parameter of the first resource pool is less than the third preset threshold value; and in a case where the value of the first parameter of the first resource pool is less than the third preset threshold value, the first terminal takes the first resource pool on the second carrier as the reselected first transmission resource.

Optionally, the first terminal determines whether the first reference value of the second carrier is less than the second preset threshold value firstly; in a case where the first reference value of the second carrier is not less than the second preset threshold value, then determines whether the value of the first parameter of the first resource pool is less than the third preset threshold value; and in a case where the value of the first parameter of the first resource pool is less than the third preset threshold value, the first terminal takes the first resource pool on the second carrier as the reselected first transmission resource.

Although determination conditions of the this manner is the same as that of Manner 6, in the actual processing, the first terminal may be configured in advance, based on differences in actual conditions such as a current scenario or a current service, to adopt one of Manners 6 and 7 as the actual processing manner for determining the reselected first transmission resource. For example, when the current service does not need to occupy more resources, Manner 7 may be adopted; and for another example, one of Manners 6 and 7 may be manually directly selected to control the first terminal to determine the specific processing manner of the reselected first transmission resource.

Manner 8: in a case where the first reference value of the second carrier is not less than a second preset threshold value and/or a value of a first parameter of a first resource pool is not less than a third preset threshold value, the first terminal selects a third carrier, where the third carrier is different from the second carrier, the first resource pool is a resource pool in which a resource currently used by the first terminal for data transmission is located; and the first terminal determines a fourth resource pool on the third carrier and takes the fourth resource pool on the third carrier as the reselected first transmission resource.

Optionally, the first terminal only determines whether the first reference value of the second carrier is less than the second preset threshold value; and in a case where the first reference value of the second carrier is not less than the second preset threshold value, the first terminal selects the third carrier.

Optionally, the first terminal only determines whether the value of the first parameter of the first resource pool is less than the third preset threshold value; and in a case where the value of the first parameter of the first resource pool is not less than the third preset threshold value, the first terminal selects the third carrier.

Optionally, the first terminal only determines whether the first reference value of the second carrier is less than the second preset threshold value; in a case where the first reference value of the second carrier is not less than the second preset threshold value, then determines whether the value of the first parameter of the first resource pool is less than the third preset threshold value; and in a case where the value of the first parameter of the first resource pool is not less than the third preset threshold value, the first terminal selects the third carrier.

In this manner, the manner of the first terminal selecting the third carrier is the same as that of Manner 2, and the description will not be repeated here.

After determining the third carrier, in this manner, the first terminal determines the fourth resource pool on the third carrier, and takes the fourth resource pool on the third carrier as the reselected first transmission resource.

The operation of the first terminal determining the fourth resource pool on the third carrier may include: arbitrarily selecting, by the first terminal, any one from the one or more resource pools on the third carrier as the fourth resource pool; or selecting, by the first terminal, any one whose value of the first parameter is less than the third preset threshold value from the one or more resource pools on the third carrier as the fourth resource pool; or selecting, by the first terminal, one with a minimum first parameter from the one or more resource pools on the third carrier as the fourth resource pool.

In this manner, in a process of the first terminal currently using the first resource pool on the second carrier for data transmission, when transmission resource reselection is performed, in addition to needing to determine based on the first reference value of the second carrier and the value of the first parameter of the first resource pool, the carrier and the resource pool are reselected in combination with the first reference values of the multiple other carriers, exemplarily, in a case where the first reference value of the second carrier is not less than the second preset threshold value and/or the value of the first parameter of the first resource pool is not less than the third preset threshold value, the first terminal selects the third carrier; and the first terminal determines the fourth resource pool on the third carrier and takes the fourth resource pool on the third carrier as the reselected first transmission resource.

According to above implementations, when the first terminal currently uses the second carrier or the first resource pool on the second carrier for data transmission, if transmission resource reselection is performed, at least one of above multiple manners may be adopted to determine the reselected first transmission resource. In this way, combination with the first reference value of the second carrier and/or the values of the first parameters of the resource pools on the second carrier, reselection of the transmission resource is performed, which ensures that the reselected first transmission resource is more suitable for the current resource usage condition of the terminal device, thereby improving system efficiency.

In connection with FIG. 4, processing of primary selection and reselection in the above implementations is exemplarily illustrated, and in following examples, the first parameter is represented as a CBR. Firstly, the first terminal performs primary selection of a first transmission resource from N carriers, which may include the following steps.

S401, the first terminal triggers a transmission resource selection.

S402, the first terminal determines a first reference value of each of the N carriers based on values of CBRs respectively corresponding to one or more resource pools on each of the N carriers.

S403, the first terminal selects, based on the first reference value of each of the N carriers, K first available carriers whose first reference values are less than a first preset threshold value.

S404, the first terminal selects, from the K first available carriers, an available carrier with a minimum first reference value as a first carrier, and takes the first carrier as the first transmission resource.

After completing the primary selection, the first carrier may be taken as the first transmission resource determined by the primary selection. Assuming that the transmission resource reselection is performed for the first time after the primary selection, the second carrier is the first carrier, and an exemplary description of obtaining a reselected first transmission resource may be as following.

S405, in a case where a first reference value of the first carrier is less than a second preset threshold value, the first carrier is taken as the reselected first transmission resource.

That is, after the processing of reselection, if the first reference value of the first carrier maintains less than the second preset threshold value, the first carrier may be taken as the reselected first transmission resource. It should be noted that this is only an exemplary illustration, and more processing manners have been described in detail in the above embodiments, and will not be exhaustive enumeration here.

In a possible implementation, the N carriers are N third available carriers; and N is an integer greater than 1.

The present implementation is different from all the above implementations, when performing the primary selection of transmission resource in the present implementation, selection of the first transmission resource is directly performed on the N third available carriers. In this way, resource selection efficiency may be further improved.

A fourth preset threshold value may be configured according to actual conditions, configured by a first network device, determined by the first terminal, or configured by a second terminal. A value of the fourth preset threshold value may be the same as or different from any one of the first preset threshold value, second preset threshold value and third preset threshold value, all of which are within the protection scope of the present embodiments.

The N third available carriers are configured by a network device, determined by the first terminal, or configured by a second terminal.

There is a third mapping relationship between the N third available carriers and a second parameter.

The second parameter may be a service-related parameter. The related description of the second parameter is the same as that of the above embodiments, and the description will not be repeated here. Further, the N third available carriers are determined by the first terminal or configured by the second terminal. Accordingly, the first terminal may further transmit related information of the N third available carriers (such as identifiers, serial numbers, or index numbers of the N third available carriers) to the first network device.

The third mapping relationship may be any one of a third set of mapping relationships. The third set of mapping relationships may include: related information of each carrier in multiple carriers, and a mapping relationship between each carrier and a candidate value of the second parameter. That is, the first terminal may determine, based on the current value of the second parameter and the third set of mapping relationships, one or more carriers having a third mapping relationship with the current value of the second parameter, and takes the one or more carriers as the N third available carriers.

For example, assume that the second parameter is a name of a service; the third set of mapping relationships may include: a mapping relationship between a name of service 1 and carriers 1 and 3, a mapping relationship between a name of service 2 and carrier 2, a mapping relationship between a name of service 3 and carrier 4, or the like. If the current value of the second parameter is the name of service 1, the third mapping relationship may be determined to be the mapping relationship between the name of service 1 and carriers 1 and 3, and carriers 1 and 3 may be used as the N third available carriers.

One or more resource pools on an x-th third available carrier of the N third available carriers may refer to:
all resource pools on the x-th third available carrier; or specified resource pools on the x-th third available carrier; where x is a positive integer less than or equal to N.

Here, the x-th third available carrier is any one of the N third available carriers, and the definition of one or more resource pools on other third available carriers of the N third available carriers may be the same as that of the x-th third available carrier, and details will not be repeatedly described. The definition of the all resource pool or specified resource pools is the same as that of the above embodiments, and the description will not be repeated here.

Before performing the S310, the first terminal may measure to obtain values of first parameters respectively corresponding to one or more resource pools on each of the N third available carriers. Any one of the N third available carriers is referred to as the x-th third available carrier, where x is a positive integer less than or equal to N, and a value of a first parameter corresponding to each resource pool in one or more resource pools on the x-th third available carrier is measured by the first terminal or a default value. The manner of obtaining the value of the first parameter corresponding to each resource pool is the same as the manner of obtaining the value of the first parameter of the j-th resource pool on the i-th carrier in the above embodiments, and the description will not be repeated here.

The first terminal performs the S310, the operation of the first terminal determining the first transmission resource based on the values of the first parameters respectively corresponding to the one or more resource pools on each of the N carriers includes: selecting, by the first terminal from one or more resource pools on each of the N third available carriers, a fourth resource pool whose value of a first parameter is less than a fourth preset threshold value; and taking the fourth resource pool as the first transmission resource.

The operation of first terminal selecting the fourth resource pool whose value of the first parameter is less than the fourth preset threshold value from the one or more resource pools on each of the N third available carriers includes: selecting, by the first terminal from the one or more resource pools on each of the N third available carriers, one or more candidate resource pools whose values of first parameters are less than the fourth preset threshold value; and selecting, by the first terminal, the fourth resource pool from the one or more candidate resource pools.

The operation of first terminal selecting the fourth resource pool from the one or more candidate resource pools may have several following implementations. In an example, the first terminal arbitrarily selects any one candidate resource pool from the one or more candidate resource pools as the fourth resource pool. In another example, the first terminal selects, from the one or more candidate resource pools, a candidate resource pool with a minimum value of a first parameter as the fourth resource pool. In yet another example, the first terminal selects, from the one or more candidate resource pools, a candidate resource pool with a highest priority as the fourth resource pool. It should be understood that the above description is merely an exemplary illustration, and in actual processing, other preset strategies may be adopted for selection, for example, a candidate resource pool with a minimum load may be selected from the one or more candidate resource pools as the fourth resource pool, or the like, which is not exhaustive enumeration here.

After the processing of the primary selection is completed, the fourth resource pool may be taken as the first transmission resource. Further, if it is necessary to perform the transmission resource reselection, one of the following manners may be adopted.

Manner 1, in a case where a value of a first parameter of a fifth resource pool is less than a fifth preset threshold value, the first terminal takes the fifth resource pool as a reselected first transmission resource; where the fifth resource pool is a resource pool in which a resource currently used by the first terminal for data transmission is located.

The fifth resource pool and the fourth resource pool may be the same or different. For example, the fifth transmission resource is the same as the fourth transmission resource when performing resource transmission reselection for the first time after the primary selection is completed; and the fifth transmission resource and the fourth transmission resource may be the same or different when performing resource transmission reselection after the last resource transmission reselection is completed, which are within the protection scope of the present embodiments. Unless otherwise specified, the description of the fifth resource pool hereinafter is the same as the description of the fifth resource pool in this manner, and the description will not be repeated.

In a case where the first terminal takes the fifth resource pool as the resource pool in which the resource currently used for data transmission is located, once it is determined that the reselection is started, the first terminal may determine whether the value of the first parameter of the fifth resource pool is less than the fifth preset threshold value, and if so, the fifth resource pool may be taken as the reselection first transmission resource.

The fifth preset threshold value may be configured according to actual conditions, configured by the first network device, determined by the first terminal, or configured by the second terminal. A value of the fifth preset threshold value may be same as or different from any one of the first preset threshold value, second preset threshold value, third preset threshold value and fourth preset threshold value, all of which are within the protection scope of the present embodiments.

Manner 2: in a case where a value of a first parameter of a fifth resource pool is not less than a fifth preset threshold value, the first terminal selects a sixth resource pool from one or more resource pools on a carrier in which the fifth resource pool is located, where the fifth resource pool is a resource pool in which a resource currently used by the first terminal for data transmission is located; and the first terminal takes the sixth resource pool as a reselected first transmission resource.

That is, when the first terminal determines to start this reselection, it may be determined whether the value of the first parameter of the fifth resource pool is less than the fifth preset threshold value, and if not, other resource pools may be reselected as the reselected first transmission resource.

The carrier in which the fifth resource pool is located is any one of the N third available carriers.

The operation of selecting the sixth resource pool from the one or more resource pools on the carrier in which the fifth resource pool is located includes at least one of: selecting, from the one or more resource pools on the carrier in which the fifth resource pool is located, a sixth resource pool whose value of a first parameter is less than the fifth preset threshold value; selecting, from the one or more resource pools on the carrier in which the fifth resource pool is located, a sixth resource pool with a minimum value of a first parameter; or selecting any one of the one or more resource pools on the carrier in which the fifth resource pool is located as the sixth resource pool.

The operation of selecting, from the one or more resource pools on the carrier in which the fifth resource pool is located, the sixth resource pool whose value of the first parameter is less than the fifth preset threshold value may be: selecting, from the one or more resource pools on the carrier in which the fifth resource pool is located, one or more resource pools whose values of the first parameters are less than the fifth preset threshold value, and selecting any one of the one or more resource pools whose values of the first parameters are less than the fifth preset threshold value as the sixth resource pool.

Here, regarding to the processing of selecting, from the one or more resource pools on the carrier in which the fifth resource pool is located, the one or more resource pools whose values of the first parameters are less than the fifth preset threshold value, which may be: selecting, from the one or more resource pools other than the fifth resource pool on the carrier in which the fifth resource pool is located, the one or more resource pools whose values of the first parameters are less than the fifth preset threshold value; or selecting, from the one or more resource pools on the carrier in which the fifth resource pool is located (that is, the fifth resource pool may be included), the one or more resource pools whose values of the first parameters are less than the fifth preset threshold value.

By adopting this manner, when performing transmission resources reselection, other resource pools on the carrier in which the currently used resource pool is located may be preferentially selected. In this way, switching between carriers may be avoided, thereby ensuring the communication efficiency.

Manner 3, in a case where a value of a first parameter of a fifth resource pool is not less than a fifth preset threshold value, the first terminal selects a seventh resource pool based on values of first parameters respectively corresponding to the one or more resource pools on each of the N third available carriers, where the fifth resource pool is a resource pool in which a resource currently used by the first terminal for data transmission is located; and the first terminal takes the seventh resource pool as a reselected first transmission resource.

In this processing manner, the first terminal, when performing transmission resource reselection, may perform the resource pool reselection on all N third available carriers. As such, the seventh resource pool may be selected from each resource pool on each third available carrier, or the seventh resource pool may be selected from each resource pool other than the fourth resource pool on each third available carrier.

The operation of selecting the seventh resource pool based on the values of the first parameters respectively corresponding to the one or more resource pools on each of the N third available carriers includes at least one of: selecting, from the one or more resource pools on each of the N third available carriers, a seventh resource pool whose value of a first parameter is less than the fifth preset threshold value; or selecting, from the one or more resource pools on each of the N third available carriers, a seventh resource pool with a minimum value of a first parameter.

That is, it may be determined again whether the value of the first parameter of each resource pool on each third available carrier currently measured is less than the fifth preset threshold value, and if there is only one resource pool whose value of the first parameter is less than the fifth preset threshold value, the resource pool is taken as the seventh resource pool; and if there are the multiple resource pools whose values of the first parameters are less than the fifth preset threshold value, any one of the multiple resource pools whose values of the first parameters are less than the fifth preset threshold value may be arbitrarily selected as the seventh resource pool.

Alternatively, instead of needing to determine again whether the value of the first parameter of each resource pool on each third available carrier currently measured is less than the fifth preset threshold value, a resource pool with a minimum value of the first parameter is selected from each resource pool on each third available carriers.

Alternatively, any resource pool other than the fifth resource pool may also be selected as the seventh resource pool from the one or more resource pools on each of the N third available carriers.

Through the above processing, the reselected first transmission resource may be obtained. Since the reselected first transmission resource ensures that the value of the first parameter is less, the communication effect as well as efficiency when using the reselected first transmission resource for subsequently data transmission may be ensured.

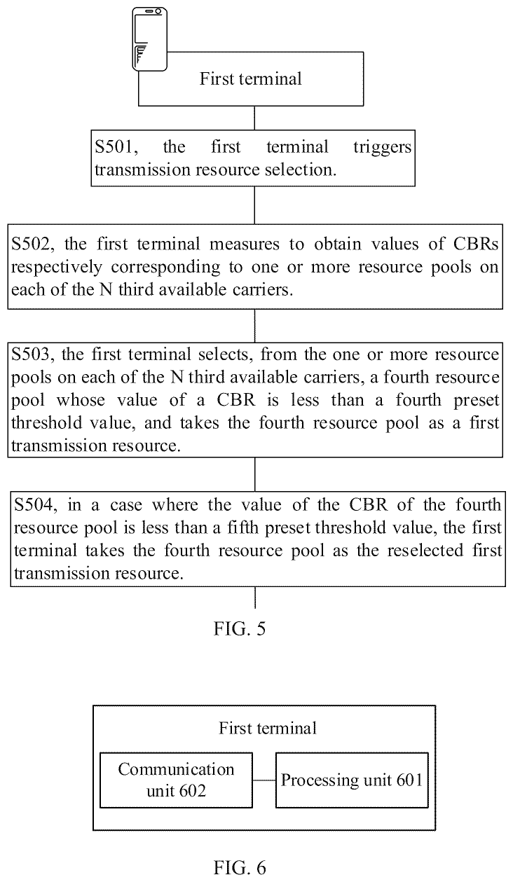

Combined with FIG. 5, the processing of primary selection and reselection in the present implementations is exemplarily illustrated, and in the following examples, the first parameter is represented as a CBR. Firstly, the first terminal performs primary selection of a first transmission resource from N third available carriers, which may include the following steps.

S501, the first terminal triggers transmission resource selection.

S502, the first terminal measures to obtain values of CBRs respectively corresponding to one or more resource pools on each of the N third available carriers.

S503, the first terminal selects, from the one or more resource pools on each of the N third available carriers, a fourth resource pool whose value of a CBR is less than a fourth preset threshold value, and takes the fourth resource pool as a first transmission resource.

After completing the primary selection, the fourth resource pool may be taken as the first transmission resource determined by the primary selection. Assuming that the transmission resource reselection is performed for the first time after the primary selection, the fifth resource pool is the fourth resource pool, and an exemplary description of obtaining a reselected first transmission resource may be as following.

S504, in a case where the value of the CBR of the fourth resource pool is less than a fifth preset threshold value, the first terminal takes the fourth resource pool as the reselected first transmission resource.

That is, after the processing of reselection, if the value of the CBR of the fourth resource pool maintains less than the fifth preset threshold value, the fourth resource pool may be maintained as the reselected first transmission resource. It should be noted that this is only an exemplary illustration, and more processing manners have been described in detail in the above embodiments, and will not be exhaustive enumeration here.

By adopting the above solutions, the first terminal determines the first transmission resource based on the values of the first parameters respectively corresponding to the one or more resource pools on each of the N carriers, where the first parameter is used for indicating the resource usage state. In this way, the transmission resource that is more suitable for the current resource usage state can be selected for data transmission, thereby ensuring communication efficiency of the system.

FIG. 6 is a schematic composition structure diagram of a first terminal according to an embodiment of the present disclosure, and the first terminal includes:
a processing unit 601, configured to determine a first transmission resource based on values of first parameters respectively corresponding to one or more resource pools on each of N carriers; where a first parameter is used for indicating a resource usage state; the first transmission resource is used for data transmission; and N is an integer greater than 1.

The processing unit 601 is configured to determine a first reference value of each of the N carriers based on the values of the first parameters respectively corresponding to the one or more resource pools on each of the N carriers, where the first reference value is used to indicate a resource usage state of a carrier; and determine the first transmission resource based on the first reference value of each of the N carriers.

The processing unit 601 is configured to determine a first reference value of an i-th carrier based on values of first parameters respectively corresponding to at least part of one or more resource pools on the i-th carrier, where the i-th carrier is one of the N carriers; i is a positive integer less than or equal to N, or i is an integer less than N and greater than or equal to 0.

The at least part of one or more resource pools on the i-th carrier includes one of: all resource pools of the one or more resource pools on the i-th carrier; and one or more specified resource pools of the one or more resource pools on the i-th carrier.

The processing unit 601 is configured to take a value of a first parameter corresponding to the at least part of one or more resource pools on the i-th carrier as the first reference value of the i-th carrier, in a case where a number of the at least part of one or more resource pools on the i-th carrier is 1.

The processing unit 601 is configured to perform, based on a target mode, processing on the values of the first parameters respectively corresponding to the at least part of one or more resource pools on the i-th carrier, to obtain the first reference value of the i-th carrier, in a case where a number of the at least part of one or more resource pools on the i-th carrier is greater than 1; where the target mode is configured by a network device, or determined by the first terminal, or configured by a second terminal, or specified by a protocol.

There is a first mapping relationship between the target mode and a second parameter, and the second parameter is a service-related parameter.

The target mode includes one of: taking one of the values of the first parameters respectively corresponding to the at least part of one or more resource pools on the i-th carrier as the first reference value of the i-th carrier; and performing calculation on the values of the first parameters respectively corresponding to the at least part of one or more resource pools on the i-th carrier, to obtain the first reference value of the i-th carrier.

The one of the values of the first parameters respectively corresponding to the at least part of one or more resource pools on the i-th carrier includes one of: a maximum value in the values of the first parameters respectively corresponding to the at least part of one or more resource pools on the i-th carrier; a minimum value in the values of the first parameters respectively corresponding to the at least part of one or more resource pools on the i-th carrier; and an arbitrary value in the values of the first parameters respectively corresponding to the at least part of one or more resource pools on the i-th carrier.

The processing unit 601 is configured to perform average calculation on the values of the first parameters respectively corresponding to the at least part of one or more resource pools on the i-th carrier, to obtain the first reference value of the i-th carrier.

A value of a first parameter corresponding to each of the one or more resource pools on the i-th carrier is measured by the first terminal or a default value.

The all resource pools of the one or more resource pools on the i-th carrier are configured by a network device, or determined by the first terminal, or configured by a second terminal.

The one or more specified resource pools of the one or more resource pools on the i-th carrier are configured by a network device, or determined by the first terminal, or configured by a second terminal, or specified by a protocol, or default.

There is a second mapping relationship between the one or more specified resource pools of the one or more resource pools on the i-th carrier and a second parameter; and the second parameter is a service-related parameter.

The first terminal further includes: a communication unit 602, configured to receive first configuration information transmitted by the second terminal; where the first configuration information includes related information of the one or more specified resource pools of the one or more resource pools on the i-th carrier.

The one or more specified resource pools of the one or more resource pools on the i-th carrier includes at least one of: a resource pool in which a resource monitored by the second terminal on the i-th carrier is located; or a resource pool in which a resource whose interference value less than a preset interference threshold value of one or more resources monitored by the second terminal on the i-th carrier is located.

The processing unit is configured to select, based on the first reference value of each of the N carriers, K first available carriers whose first reference values are less than a first preset threshold, where K is a positive integer less than or equal to N; and determine, from the K first available carriers, a first carrier as the first transmission resource.

The processing unit is configured to select, from the K first available carriers, a first available carrier with a minimum first reference value as the first carrier, and take the first carrier as the first transmission resource.

The communication unit is configured to transmit first information to a second terminal, where the first information is used to indicate that the second terminal transmits a suggested carrier; and receive second information transmitted by the second terminal, where the second information includes a carrier suggested by the second terminal; and the processing unit is configured to determine the first carrier according to related information of the K first available carriers and/or the second information, and take the first carrier as the first transmission resource.

The first information includes the related information of the K first available carriers.

The carrier suggested by the second terminal is a carrier used by the second terminal.

The carrier used by the second terminal includes at least one of: a carrier used by the second terminal on a sidelink with a third device; or a carrier used by the second terminal on a link with a network device.

The processing unit is configured to determine a reselected first transmission resource based on a first reference value of a second carrier and/or values of first parameters respectively corresponding to one or more resource pools on the second carrier; where the second carrier is a carrier currently used by the first terminal for data transmission, and the second carrier is one of the N carriers.

The first reference value of the second carrier is determined based on values of first parameters respectively corresponding to the at least part of one or more resource pools on the second carrier.

The at least part of one or more resource pools on the second carrier further includes: a first resource pool on the second carrier; where the first resource pool is a resource pool in which a resource currently used by the first terminal for data transmission is located.

The processing unit is configured to take the second carrier as the reselected first transmission resource, in a case where the first reference value of the second carrier is less than a second preset threshold value and/or a value of a first parameter of a first resource pool on the second carrier is less than a third preset threshold value.

The processing unit is configured to select a third carrier, and take the third carrier as the reselected first transmission resource, in a case where the first reference value of the second carrier is not less than a second preset threshold value; where the third carrier is different from the second carrier.

The processing unit is configured to select a third carrier, and take the third carrier as the reselected first transmission resource, in a case where the first reference value of the second carrier is less than a second preset threshold value and a value of a first parameter of a first resource pool on the second carrier is not less than a third preset threshold value; where the third carrier is different from the second carrier.

The processing unit is configured to take a first resource pool on the second carrier as the reselected first transmission resource, in a case where the first reference value of the second carrier is less than a second preset threshold value and/or a value of a first parameter of the first resource pool on the second carrier is less than a third preset threshold value; where the first resource pool is a resource pool in which a resource currently used by the first terminal for data transmission is located.

The processing unit is configured to select a second resource pool on the second carrier, in a case where the first reference value of the second carrier is less than a second preset threshold value and a value of a first parameter of a first resource pool is not less than a third preset threshold value; where the second resource pool is one of one or more third resource pools on the second carrier other than the first resource pool; and determine that the second resource pool on the second carrier is the reselected first transmission resource.

The processing unit is configured to select a second resource pool on the second carrier, in a case where the first reference value of the second carrier is not less than a second preset threshold value and/or a value of a first parameter of a first resource pool is less than a third preset threshold value; where the first resource pool is a resource pool in which a resource currently used by the first terminal for data transmission is located, and the second resource pool is one of one or more third resource pools on the second carrier other than the first resource pool; and determine that the second resource pool on the second carrier is the reselected first transmission resource.

A value of a first parameter of each of the one or more third resource pools is less than the third preset threshold value.

The processing unit is configured to take a first resource pool on the second carrier as the reselected first transmission resource, in a case where the first reference value of the second carrier is not less than a second preset threshold value and/or a value of a first parameter of the first resource pool is less than a third preset threshold value; where the first resource pool is a resource pool in which a resource currently used by the first terminal for data transmission is located.

The processing unit is configured to select a third carrier, in a case where the first reference value of the second carrier is not less than a second preset threshold value and/or a value of a first parameter of a first resource pool is not less than a third preset threshold value; where the third carrier is different from the second carrier, and the first resource pool is a resource pool in which a resource currently used by the first terminal for data transmission is located; and determine a fourth resource pool on the third carrier, and take the fourth resource pool on the third carrier as the first transmission resource.

The processing unit is configured to select, based on first reference values respectively corresponding to multiple carriers, one or more second available carriers whose first reference values are less than a first preset threshold value, where the multiple carriers do not include the second carrier; and determine the third carrier from the one or more second available carriers.

The processing unit is configured to select a third carrier with a minimum first reference value from the one or more second available carriers.

The communication unit is configured to transmit third information to a second terminal, where the third information is used to indicate that the second terminal transmits a suggested carrier; and receive fourth information transmitted by the second terminal, where the fourth information includes a carrier suggested by the second terminal; and the processing unit is configured to determine the third carrier based on related information of the one or more second available carriers and/or the fourth information.

The third information includes the related information of the one or more second available carriers.

The N carriers are N third available carriers; and the processing unit is configured to select, from one or more resource pools on each of the N third available carriers, a fourth resource pool whose value of a first parameter is less than a fourth preset threshold value; and take the fourth resource pool as the first transmission resource.

The N third available carriers are configured by a network device, or determined by the first terminal, or configured by a second terminal.

There is a third mapping relationship between the N third available carriers and a second parameter, and the second parameter is a service-related parameter.

The processing unit is configured to select, from the one or more resource pools on each of the N third available carriers, one or more candidate resource pools whose values of first parameters are less than the fourth preset threshold value; and select the fourth resource pool from the one or more candidate resource pools.

The processing unit is configured to perform at least one of: selecting, from the one or more candidate resource pools, a candidate resource pool with a minimum value of a first parameter as the fourth resource pool; or selecting, from the one or more candidate resource pools, a candidate resource pool with a highest priority as the fourth resource pool.

The processing unit is configured to take a fifth resource pool as a reselected first transmission resource, in a case where a value of a first parameter of the fifth resource pool is less than a fifth preset threshold value; where the fifth resource pool is a resource pool in which a resource currently used by the first terminal for data transmission is located.

The processing unit is configured to select a sixth resource pool from one or more resource pools on a carrier in which a fifth resource pool is located, in a case where a value of a first parameter of the fifth resource pool is not less than a fifth preset threshold value; where the fifth resource pool is a resource pool in which a resource currently used by the first terminal for data transmission is located; and take the sixth resource pool as a reselected first transmission resource.

The processing unit is configured to perform at least one of: selecting, from the one or more resource pools on the carrier in which the fifth resource pool is located, a sixth resource pool whose value of a first parameter is less than the fifth preset threshold value; or selecting, from the one or more resource pools on the carrier in which the fifth resource pool is located, a sixth resource pool with a minimum value of a first parameter.

The processing unit is configured to select a seventh resource pool based on values of first parameters respectively corresponding to the one or more resource pools on each of the N third available carriers, in a case where a value of a first parameter of a fifth resource pool is not less than a fifth preset threshold value; where the fifth resource pool is a resource pool in which a resource currently used by the first terminal for data transmission is located; and take the seventh resource pool as a reselected first transmission resource.

The processing unit is configured to perform at least one of: selecting, from the one or more resource pools on each of the N third available carriers, a seventh resource pool whose value of a first parameter is less than the fifth preset threshold value; or selecting, from the one or more resource pools on each of the N third available carriers, a seventh resource pool with a minimum value of a first parameter.

The second parameter includes at least one of: related information of a service, quality of service (QOS), a layer 2 (L2) identifier, a transmission profile, a priority, a logical channel identifier, or a logical channel.

The related information of the service includes at least one of: a name of the service or an identifier of the service.

The first parameter is a channel busy rate (CBR).

The first terminal of the embodiments of the present disclosure may realize corresponding functions in the method of the above method embodiments. Processes, functions, implementations and beneficial effects corresponding to each module (submodule, unit, component, or the like) in the first terminal may be referred to the corresponding description in the above method embodiments, which will not be repeated here. It should be noted that the functions described with respect to each module (submodule, unit, component, or the like) in the first terminal of the embodiments of the present disclosure may be implemented by different modules (submodules, units, components, or the like), or may be implemented by the same module (submodule, unit, component, or the like).

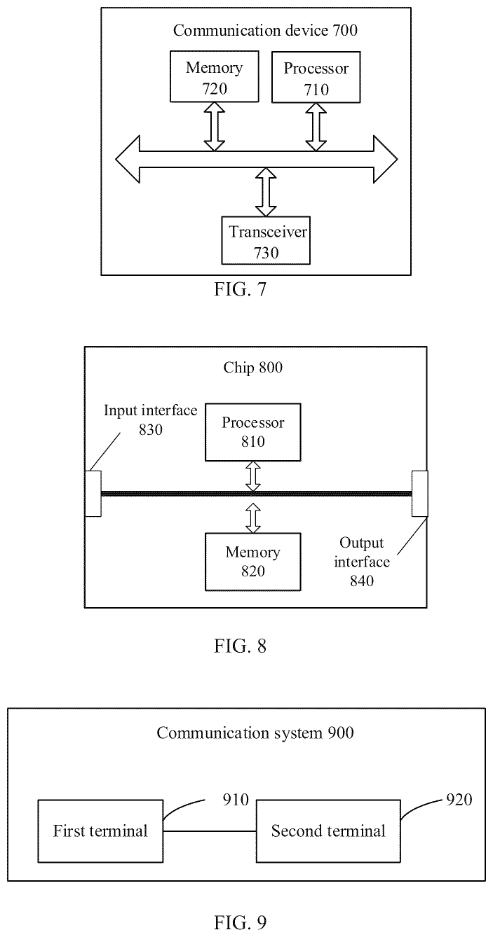

FIG. 7 is a schematic structural diagram of a communication device 700 according to the embodiments of the present disclosure. The communication device 700 includes a processor 710, and processor 710 may call and run a computer program from a memory to cause the communication device 700 to implement the methods in the embodiments of the present disclosure.

In a possible implementation, the communication device 700 may also include a memory 720. The processor 710 may call and run a computer program from the memory 720 to cause the communication device 700 to implement the methods in the embodiments of the present disclosure. The memory 720 may be a separate device independent from the processor 710 or may also be integrated into the processor 710.

In a possible implementation, the communication device 700 may also include a transceiver 730, and the processor 710 may control the transceiver 730 to communicate with other devices, and exemplarily, to transmit information or data to other devices, or receive information or data transmitted by the other devices. The transceiver 730 may include a transmitter and a receiver. The transceiver 730 may further include an antenna. A quantity of the antenna may be one or more.

In a possible implementation, the communication device 700 may be a first terminal of the embodiments of the present disclosure, and the communication device 700 may implement the corresponding processes implemented by the first terminal in various methods of the embodiments of the present disclosure, which will not be repeated here for the sake of brevity.

FIG. 8 is a schematic structural diagram of a chip 800 according to the embodiments of the present disclosure. The chip 800 includes a processor 810, and the processor 810 may call and run a computer program from a memory to implement the methods in the embodiments of the present disclosure.

In a possible implementation, the chip 800 may also include a memory 820. The processor 810 may call and run a computer program from the memory 820 to implement the methods performed by the first terminal or the electronic device in the embodiments of the present disclosure. The memory 820 may be a separate device independent from the processor 810, or may also be integrated into the processor 810.

In a possible implementation, the chip 800 may further include an input interface 830. The processor 810 may control the input interface 830 to communicate with other devices or chips, and exemplarily, to obtain information or data transmitted by other devices or chips.

In a possible implementation, the chip 800 may further include an output interface 840. The processor 810 may control the output interface 840 to communicate with other devices or chips, and exemplarily, to output information or data to other devices or chips.

In a possible implementation, the chip may be applied to the first terminal in the embodiments of the present disclosure, and the chip may implement the corresponding processes implemented by the first terminal in the various methods of the embodiments of the present disclosure, which will not be repeated here for the sake of brevity.

It should be understood that, the chip mentioned in the embodiments of the present disclosure may also be referred to as a system-level chip, a system chip, a chip system or a system-on-chip, or the like.

The processor mentioned above may be a general-purpose processor, a digital signal processor (DSPS), a field programmable gate array (FPGA), an application specific integrated circuit (ASIC), other programmable logic devices, transistor logic devices or discrete hardware components, or the like. The general-purpose processor mentioned above may be a microprocessor or may also be any conventional processor, or the like.

The memory mentioned above may be a volatile (transitory) memory or a non-volatile (non-transitory) memory, or may include both the volatile memory and the non-volatile memory. Here, the non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM) or flash memory. The volatile memory may be a random access memory (RAM).

It should be understood that the above memory is exemplary but not limited illustration. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM)), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct Rambus random access memory (Direct Rambus RAM, DR RAM), or the like. That is, the memory in the embodiments of the present disclosure is intended to include, but not limited to, these and any other suitable types of memories.

FIG. 9 is a schematic block diagram of a communication system 900 according to the embodiments of the present disclosure. The communication system 900 includes a first terminal 910 and a second terminal 920.

The first terminal 910 may be configured to implement corresponding functions implemented by the first terminal in the above methods, and the second terminal 920 may be configured to implement corresponding functions implemented by the second terminal in the above methods, which will not be repeated here for the sake of brevity.

The above embodiments may be implemented in whole or in part by software, hardware, firmware, or any combination thereof. When the above embodiments are implemented by using software, they may be implemented in a form of a computer program product in whole or in part. The computer program product includes one or more computer instructions. When computer program instructions are loaded and executed on a computer, processes or functions according to the embodiments of the present disclosure are generated in whole or in part. The computer may be a general-purpose computer, a dedicated computer, a computer network, or any other programmable apparatus. The computer instructions may be stored in a computer readable storage medium or transmitted from one computer readable storage medium to another computer readable storage medium, for example, the computer instructions may be transmitted from a website site, computer, server, or data center to another website site, computer, server, or data center via wired (such as coaxial cable, fiber optic, digital subscriber line (DSL)) or wireless (such as infrared, radio, microwave) means. The computer readable storage medium may be any available medium that can be accessed by the computer, or a data storage device, such as including a server or a data center that integrates one or more available mediums. The available medium may be a magnetic medium (e.g., a floppy disk, a hard disk or a magnetic tape), an optical medium (e.g., a digital video disk (DVD)), a semiconductor medium (e.g., a solid state disk (SSD)), or the like.

It should be understood that, in the various embodiments of the present disclosure, a size of serial numbers of the above processes does not imply an order of execution, and the execution order of the respective processes should be determined by their function and internal logic, but should not constitute any limitation on the implementation processes of the embodiments of the present disclosure.

Those skilled in the art may clearly understand that, for the convenience and brevity of the description, the specific working processes of the systems, apparatus and units described above may refer to the corresponding processes in the above method embodiments, which will not be repeated here.

The foregoing descriptions are merely specific implementations of the present disclosure, but the protection scope of the present disclosure is not limited thereto. Any skilled person in the art could readily conceive of changes or replacements within the technical scope of the present disclosure, which shall be all included in the protection scope of the present disclosure. Therefore, the protection scope of the present disclosure shall be subject to the protection scope of claims.

What is claimed is:

1. A transmission resource selection method, comprising:
determining, by a first terminal, a first transmission resource based on values of first parameters respectively corresponding to one or more resource pools on each of N carriers;
wherein a first parameter is used for indicating a resource usage state; the first transmission resource is used for data transmission; and N is an integer greater than 1.

2. The method according to claim 1, wherein determining, by the first terminal, the first transmission resource based on the values of the first parameters respectively corresponding to the one or more resource pools on each of the N carriers comprises:
determining, by the first terminal, a first reference value of an i-th carrier based on values of first parameters respectively corresponding to at least part of one or more resource pools on the i-th carrier, wherein the i-th carrier is one of the N carriers; i is a positive integer less than or equal to N, or i is an integer less than N and greater than or equal to 0; and
determining the first transmission resource based on the first reference value of each of the N carriers.

3. The method according to claim 2, wherein the at least part of one or more resource pools on the i-th carrier comprises one of:
all resource pools of the one or more resource pools on the i-th carrier; and
one or more specified resource pools of the one or more resource pools on the i-th carrier.

4. The method according to claim 2, wherein determining, by the first terminal, the first reference value of the i-th carrier based on the values of the first parameters respectively corresponding to the at least part of one or more resource pools on the i-th carrier comprises:
in a case where a number of the at least part of one or more resource pools on the i-th carrier is 1, taking a value of a first parameter corresponding to the at least part of one or more resource pools on the i-th carrier as the first reference value of the i-th carrier; or
in a case where a number of the at least part of one or more resource pools on the i-th carrier is greater than 1, performing, by the first terminal based on a target mode, processing on the values of the first parameters respectively corresponding to the at least part of one or more resource pools on the i-th carrier, to obtain the first reference value of the i-th carrier; wherein the target mode is configured by a network device, or determined by the first terminal, or configured by a second terminal, or specified by a protocol.

5. The method according to claim 4, wherein the target mode comprises one of:
taking one of the values of the first parameters respectively corresponding to the at least part of one or more resource pools on the i-th carrier as the first reference value of the i-th carrier; and
performing calculation on the values of the first parameters respectively corresponding to the at least part of one or more resource pools on the i-th carrier, to obtain the first reference value of the i-th carrier.

6. The method according to claim 2, wherein a value of a first parameter corresponding to each of the one or more resource pools on the i-th carrier is measured by the first terminal or a default value.

7. The method according to claim 3, wherein the all resource pools of the one or more resource pools on the i-th carrier are configured by a network device, or determined by the first terminal, or configured by a second terminal; or
the one or more specified resource pools of the one or more resource pools on the i-th carrier are configured by a network device, or determined by the first terminal, or configured by a second terminal, or specified by a protocol, or default.

8. The method according to claim 2, wherein determining the first transmission resource based on the first reference value of each of the N carriers comprises:
selecting, by the first terminal based on the first reference value of each of the N carriers, K first available carriers whose first reference values are less than a first preset threshold, wherein K is a positive integer less than or equal to N; and
determining, by the first terminal from the K first available carriers, a first carrier as the first transmission resource.

9. The method according to claim 8, wherein determining, by the first terminal from the K first available carriers, the first carrier as the first transmission resource comprises:
selecting, by the first terminal from the K first available carriers, a first available carrier with a minimum first reference value as the first carrier, and taking the first carrier as the first transmission resource.

10. The method according to claim 3, further comprising:
determining, by the first terminal, a reselected first transmission resource based on a first reference value of a second carrier and/or values of first parameters respectively corresponding to one or more resource pools on the second carrier; wherein the second carrier is a carrier currently used by the first terminal for data transmission, and the second carrier is one of the N carriers; and
wherein the first reference value of the second carrier is determined based on values of first parameters respectively corresponding to the at least part of one or more resource pools on the second carrier.

11. The method according to claim 10, wherein determining, by the first terminal, the reselected first transmission resource based on the first reference value of the second carrier and/or the values of the first parameters respectively corresponding to the one or more resource pools on the second carrier comprises:
in a case where the first reference value of the second carrier is less than a second preset threshold value and/or a value of a first parameter of a first resource pool on the second carrier is less than a third preset threshold value, taking, by the first terminal, the second carrier as the reselected first transmission resource.

12. The method according to claim 1, wherein the first parameter is a channel busy rate (CBR).

13. A first terminal, comprising: a processor and a memory, wherein the memory is configured to store a computer program, and the processer is configured to call and run the computer program stored in the memory, to cause the first terminal to perform:
determining a first transmission resource based on values of first parameters respectively corresponding to one or more resource pools on each of N carriers; wherein a first parameter is used for indicating a resource usage state; the first transmission resource is used for data transmission; and N is an integer greater than 1.

14. The first terminal according to claim 13, wherein the processer is configured to call and run the computer program stored in the memory, to cause the first terminal further to perform:
determining a first reference value of an i-th carrier based on values of first parameters respectively corresponding to at least part of one or more resource pools on the i-th carrier, wherein the i-th carrier is one of the N carriers; i is a positive integer less than or equal to N, or i is an integer less than N and greater than or equal to 0; and
determining the first transmission resource based on the first reference value of each of the N carriers.

15. The first terminal according to claim 14, wherein the at least part of one or more resource pools on the i-th carrier comprises one of:
all resource pools of the one or more resource pools on the i-th carrier; and
one or more specified resource pools of the one or more resource pools on the i-th carrier.

16. The first terminal according to claim 14, wherein the processer is configured to call and run the computer program stored in the memory, to cause the first terminal further to perform:
in a case where a number of the at least part of one or more resource pools on the i-th carrier is 1, taking a value of a first parameter corresponding to the at least part of one or more resource pools on the i-th carrier as the first reference value of the i-th carrier; or
in a case where a number of the at least part of one or more resource pools on the i-th carrier is greater than 1, performing, based on a target mode, processing on the values of the first parameters respectively corresponding to the at least part of one or more resource pools on the i-th carrier, to obtain the first reference value of the i-th carrier; wherein the target mode is configured by a network device, or determined by the first terminal, or configured by a second terminal, or specified by a protocol.

17. The first terminal according to claim 14, wherein the processer is configured to call and run the computer program stored in the memory, to cause the first terminal further to perform:
selecting, based on the first reference value of each of the N carriers, K first available carriers whose first reference values are less than a first preset threshold, wherein K is a positive integer less than or equal to N; and
determining, from the K first available carriers, a first carrier as the first transmission resource.

18. The first terminal according to claim 17, wherein the processer is configured to call and run the computer program stored in the memory, to cause the first terminal further to perform:
selecting, from the K first available carriers, a first available carrier with a minimum first reference value as the first carrier, and taking the first carrier as the first transmission resource.

19. The first terminal according to claim 15, wherein the processer is configured to call and run the computer program stored in the memory, to cause the first terminal further to perform:
determining a reselected first transmission resource based on a first reference value of a second carrier and/or values of first parameters respectively corresponding to one or more resource pools on the second carrier; wherein the second carrier is a carrier currently used by the first terminal for data transmission, and the second carrier is one of the N carriers; and
wherein the first reference value of the second carrier is determined based on values of first parameters respectively corresponding to the at least part of one or more resource pools on the second carrier.

20. A non-transitory computer-readable storage medium, configured to store a computer program, wherein the computer program, when being executed by a device, causes the device to perform:
determining a first transmission resource based on values of first parameters respectively corresponding to one or more resource pools on each of N carriers; wherein a first parameter is used for indicating a resource usage state; the first transmission resource is used for data transmission; and N is an integer greater than 1.
